(19) United States
(12) Patent Application Publication
(10) Pub. No.: US 2004/0034829 A1
(43) Pub. Date: Feb. 19, 2004

(54) Layout system, layout program, and layout method

(75) Inventors: Hirotaka Ohashi, Chino-shi (JP); Takashi Nitta, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/608,567

(22) Filed: Jun. 30, 2003

(30) Foreign Application Priority Data
Jul. 9, 2002 (JP) 2002-200418

(51) Int. Cl. G06F 15/00

(52) U.S. Cl. 715/500.1

(57) ABSTRACT

The invention provides a layout system suitable to reduce or prevent layout frames from being left blank and to adjust the layout in accordance with the contents or properties of article information. A content distribution terminal determines whether there is a layout frame and article information having added thereto identical identification information by comparing the identification information added to the article information with that added to the layout frame. The content distribution terminal, when it is determined that there is a layout frame and article information having added thereto identical identification information, stores the article information in the layout frame. The content distribution terminal, when it is determined that there is no layout frame and article information having added thereto the identical identification information, stores the article information in the layout frame on the basis of arrangement control information added to the layout frame and the article information.

### BACKGROUND OF THE INVENTION

1. Field of Invention

The present invention relates to a system, a program and a method of formulating or modifying a document. More specifically, the invention relates to a layout system, a layout program and a layout method suitable to reduce or prevent a layout frame from being left blank and suitable to adjust the layout in accordance with the contents or properties of article information.

2. Description of Related Art

The related art includes a digital content distribution system to provide digital contents, such as news materials, to a user, and the digital content distribution system generally reads some article information from the article information registration database (hereinafter “database” or “DB”), edits the read article information and distributes the completely-edited digital contents to the user. In the process of editing the digital contents, a layout for the digital contents is made for the user to read with ease. For example, it is general that a plurality of layout frames are arranged in a layout region to store article information to be stored in the layout frames one after another.

The related art includes a device to make a layout for article information, for example, a character data allocation device (hereinafter “first related art example”) disclosed in Japanese Unexamined Patent Application Publication No. 9-76450 and a document layout device (hereinafter “second related art example”) disclosed in Japanese Unexamined Patent Application Publication No. 2000-207396.

In the first related art example, the character data allocation device includes a character data input part to input character data having added thereto composition conditions and region recognition symbols, a character data storage part to store character data, a layout frame setting part to set up layout frames allocated with the character data, a region recognition symbol input part to add region recognition symbols in the layout frames, a layout frame storage part to store the layout frames, an allocation processing part to read the character data and layout frames and to stream the character data corresponding to the read region recognition symbols, in the layout frames, and a display unit to display the layout streamed into by the allocation processing part.

This makes it possible to easily perform an allocating operation by automatically streaming character data in the layout frames in the case of allocating a plurality of character data to a designated region.

In the second related art example, first, a plurality of elemental contents are grouped in one content group. Next, a plurality of layout groups are prepared correspondingly to the content group. Elemental layouts each composed of one frame, etc., are grouped to constitute the layout group. To the elemental contents and layouts, correspondence identification information indicating the correspondence relationship therebetween is given. In laying out a document, the content group is made to correspond to the desired layout group. A document layout device automatically decides the correspondence between individual elemental contents and elemental layouts in the corresponding groups based on the correspondence identification information. In the case of changing the layout for the document, the content group may be made to correspond to another layout group.

This makes it possible to facilitate the process of making a plurality of contents and layout frames correspond to each other, in a document layout device of type that makes contents correspond to layout frames.

### SUMMARY OF THE INVENTION

However, in the first related art example, the character data are to be streamed in the layout frames having added thereto region recognition symbols identical thereto, so that there may be a possibility of leaving the layout frames blank if there is no character data having added thereto region recognition symbols identical to those in the layout frames. Further, some character data must be streamed in the layout frames having added thereto the identical region recognition symbols, while other character data need not be streamed in the layout frames having added thereto identical region recognition symbols. Therefore, it has been difficult to select layout frames in accordance with the contents or properties of character data.

Moreover, in the second related art example, the contents are to be streamed in the layout frames having added thereto identical identification information, so that there may be a possibility of leaving the layout frames blank if there are no contents having added thereto the identification information identical to that in the layout frames. In addition, some character data must be streamed in the layout frames having added thereto identical identification information, while other character data do not have to be streamed in the layout frames having added thereto the identical identification information. Therefore, it has been difficult to select layout frames in accordance with the contents or properties of character data.

The present invention addresses or solves the above and/or other problems, and provides a layout system, a layout program and a layout method suitable to reduce or prevent layout frames from being left blank and to adjust the layout in accordance with the contents or properties of article information.

In order to address or accomplish the above, a first aspect of the invention provides a layout system including a layout device to select published information from a plurality of pieces of published information and to make a layout for the selected published information, the layout device performing a layout process by storing the selected published information in information storage regions arranged in a layout region.

The information storage regions and the published information have respectively added thereto identification information to make the information storage regions and the published information correspond to each other, and the published information has added thereto arrangement control information for controlling the arrangement in the information storage regions.

The layout device is adapted to store the published information in the information storage regions on the basis of the arrangement control information when there is no information storage region or published information suitable to store the published information in the information storage regions on the basis of the identification information.

According to the layout system thus constructed, the layout device stores published information in an information storage region on the basis of identification information of the information storage region or the published information. At this time, the layout device stores the published information in the information storage region on the basis of arrangement control information of the published information when there is no suitable information storage region or published information.

In the above case, a step of adding the identification information to the information storage region includes filling the identification information in the information storage region and relating the identification information to the information storage region.

In the latter case, for example, a table or database (DB) can be used to perform the step. In other words, any type is acceptable if the correspondence between the information storage region and identification information can be directly or indirectly confirmed therefrom. This is applicable to the enclosure of identification information and arrangement control information with the published information. Hereinafter, this is also applicable to the layout system in the second aspect of the invention, the layout program of the twenty-first and twenty-second aspects of the invention, and the layout method in the twenty-fifth and twenty-sixth aspects of the invention.

Further, the arrangement of information storage regions to the layout region, for example, may be dynamically performed at the time of making a layout for published information, or may be performed on the basis of layout definition information after a previous preparation is made for the layout definition information that defines an arrangement of a plurality of information storage regions in the layout region. Hereinafter, this is also applicable to the layout system in the second to fourth aspects of the invention, the layout program in the twenty-first to twenty-fourth aspects of the invention, and the layout method in the twenty-fifth to twenty-eighth aspects of the invention.

Further, the published information includes character data, image data and the other data. Hereinafter, this is also applicable to the layout system in the second to fourth aspects of the invention, the layout program in the twenty-first to twenty-fourth aspects of the invention, and the layout method in the twenty-fifth to twenty-eighth aspects of the invention.

Moreover, the layout indicates, for example, a display layout in the case of making a layout for published information for the purpose of displaying it on a screen or a print layout in the case of making a layout for published information for the purpose of printing it on paper. Hereinafter, this is also applicable to the layout system in the second to fourth aspects of the invention.

Moreover, the aforementioned layout system may be embodied as a single device or as a network system in which a plurality of terminals are communicably connected to each other. In the latter case, individual constructional elements may belong to any of the plurality of terminals if they are communicably connected to each other. Hereinafter, this is also applicable to the layout system in the second to fourth aspects of the invention.

Further, a second aspect of the invention provides a layout system including a published information storage device to store a plurality of pieces of published information, and a layout device to select the published information from the published information storage device and to make a layout for the selected published information, the layout device performing a layout process by storing the selected published information in information storage regions arranged in a layout region.

The information storage regions and the published information have respectively added thereto identification information to make the information storage regions and the published information correspond to each other, and the published information has added thereto arrangement control information to control the arrangement in the information storage regions; and

The layout device is adapted to determine whether there are an information storage region and published information having added thereto identical or related identification information by comparing the identification information added to the published information with that added to the information storage regions, and then, when it is determined that there are an information storage region and published information having added thereto identical or related identification information, the layout device is adapted to store relevant published information in the relevant information storage region, and when it is determined that there are no information storage regions and published information having added thereto identical or related identification information, the layout device is adapted to store the published information in the information storage regions on the basis of the arrangement control information added to the relevant published information.

According to the layout system thus constructed, the layout device determines whether there are an information storage region and published information having added thereto identical or related identification information by comparing the identification information added to the published information with that added to the information storage regions. As a result, when it is determined that there are an information storage region and published information having added thereto identical or related identification information, the published information is stored in the information storage region. Moreover, when it is determined that there are no information storage regions and published information having added thereto identical or related identification information, the published information is stored in the information storage region on the basis of the arrangement control information added to the relevant published information.

Further, a third aspect of the invention provides a layout system including a layout device to select published information from a plurality of pieces of published information and to make a layout for the selected published information, the layout device performing a layout process by storing the selected published information in information storage regions arranged in a layout region.

The information storage regions and the published information have respectively added thereto identification information to make the information storage regions and the published information correspond to each other, and arrangement control information to control the arrangement in the information storage regions.

The layout device is adapted to store the published information in the information storage regions on the basis of the arrangement control information when there is no information storage region or published information suitable to store the published information in the information storage regions on the basis of the identification information.

According to the layout system thus constructed, the layout device stores published information in an information storage region on the basis of identification information of the information storage region or the published information. At this time, the layout device stores the published information in the information storage region on the basis of arrangement control information of the information storage region or the published information when there is no suitable information storage region or published information.

In the above case, a step of adding the identification information to the information storage region includes filling the identification information in the information storage region and relating the identification information to the information storage region.

In the latter case, for example, a table or database (DB) can be used to perform the step. In other words, any type is acceptable if the correspondence between the information storage region and identification information can be directly or indirectly confirmed therefrom. This is applicable to the enclosure of arrangement control information with the information storage region and to that of identification information and arrangement control information with published information. Hereinafter, this is also applicable to the layout system in the fourth aspect of the invention, the layout program in the twenty-third and twenty-fourth aspects of the invention, and the layout method in the twenty-seventh and twenty-eighth aspects of the invention.

A fourth aspect of the invention provides a layout system including a published information storage device to store a plurality of pieces of published information, and a layout device to select the published information from the published information storage device and to make a layout for the selected published information, the layout device performing a layout process by storing the selected published information in information storage regions arranged in a layout region.

The information storage regions and the published information have respectively added thereto identification information to make the information storage regions and the published information correspond to each other, and arrangement control information to control the arrangement in the information storage regions.

The layout device is adapted to determine whether there are an information storage region and published information having added thereto identical or related identification information by comparing the identification information added to the published information with that added to the information storage regions, and then, when it is determined that there are an information storage region and published information having added thereto identical or identification information, the layout device is adapted to store relevant published information in the relevant information storage region, and when it is determined that there are no information storage regions and published information having added thereto identical or related identification information, the layout device is adapted to store the published information in the information storage region on the basis of the arrangement control information added to the information storage region and the published information.

According to the layout system thus constructed, the layout device determines whether there are an information storage region and published information having added thereto identical or related identification information by comparing the identification information added to the published information with that added to the information storage regions. As a result, when it is determined that there are an information storage region and published information having added thereto identical or related identification information, the published information is stored in the information storage region. Moreover, when it is determined that there are no information storage regions and published information having added thereto identical or related identification information, the published information is stored in the information storage region on the basis of the arrangement control information added to the information storage region or published information.

Further, a fifth aspect of the invention provides the layout system according to the fourth aspect of the invention, such that the arrangement control information can be set to either state 1 where the published information should be stored in an information storage region having added thereto identification information identical or related thereto or state 2 where the published information may be stored in an information storage region other than the one having added thereto identification information identical or related thereto.

According to the layout system thus constructed, the layout device, if the arrangement control information is set to state 1, controls the arrangement of the published information so as to be stored in the information storage region having added thereto identical or related identification information. Further, if the arrangement control information is set to state 2, the layout device controls the arrangement of the published information so as to be stored in the information storage region other than the one having added thereto identification information identical or related thereto.

Further, a sixth aspect of the invention provides the layout system according to the fifth aspect of the invention, such that when there is no published information having added thereto identification information identical or related to that added to an information storage region as a target to be stored, in the published information storage device, and when arrangement control information added to the information storage region is set to state 2, the layout device is adapted to select published information not having added thereto the identification information from the published information storage device, and to store the selected published information in the information storage region as a target to be stored.

According to the layout system thus constructed, when there is no published information having added thereto identification information identical or related to that added to an information storage region as a target to be stored, in the published information storage device, and when the arrangement control information added to the information storage region is set to state 2, the layout device selects the published information not having added thereto identification information from the published information storage device and stores the selected published information in the information storage region as a target to be stored. In other words, the published information not having added thereto identification information is selected in the case that there are no information storage regions and published information having added thereto identical or related identification information.

Moreover, a seventh aspect of the invention provides the layout system according to the sixth aspect of the invention, such that when there is no published information not having added thereto identification information, in the published information storage device, the layout device is adapted to select published information having the arrangement control information set to the state 2 from the published information storage device and to store in the information storage region as a target to be stored the selected published information.

According to the layout system thus constructed, when there is no published information not having added thereto identification information, in the published information storage device, the layout device is adapted to select the published information having the arrangement control information set to state 2 from the published information storage device and then stores in the information storage region as a target to be stored the selected published information. In other words, the published information having the arrangement control information set to state 2 is selected in the case that there are no information storage regions and published information having added thereto identical or related identification information and in the case that there is no published information not having added thereto identification information, in the published information storage device.

Further, an eighth aspect of the invention provides the layout system according to the fifth aspect of the invention, such that when there is no information storage region having added thereto identification information identical or related to that added to the published information as a target to be stored, in the layout region, and when the arrangement control information added to the published information is set to the state 2, the layout device is adapted to select an information storage region not having added thereto the identification information from the layout region and to store in the selected information storage region the published information as a target to be stored.

According to the layout system thus constructed, when there is no information storage region having added thereto identification information identical or related to that added to the published information as a target to be stored, in the layout region, and when the arrangement control information added to the published information is set to state 2, the layout device selects the information storage region not having added thereto the identification information from the layout region and stores in the selected information storage region the published information as a target to be stored. In other words, the information storage region not having added thereto identification information is selected in the case that there are no information storage regions and published information having added thereto identical or related identification information.

Further, a ninth aspect of the invention provides the layout system according to the eighth aspect of the invention, such that when there are no information storage regions not having added thereto the identification information, in the layout region, the layout device is adapted to select an information storage region having the arrangement control information set to the state 2 from the layout region, and to store in the selected information storage region the published information as a target to be stored.

According to the layout system thus constructed, when there are no information storage regions not having added thereto the identification information, in the layout region, the layout device selects the information storage region having the arrangement control information set to state 2 from the layout region, and stores in the selected information storage region the published information as a target to be stored. In other words, the information storage region having the arrangement control information set to state 2 is selected in the case that there is no information storage region having added thereto identical or related identification information and in the case that there are no information storage regions not having added thereto identification information, in the layout region.

Further, a tenth aspect of the invention provides the layout system according to the fourth aspect of the invention, such that the arrangement control information can set the similarity of identification information that is allowable when the published information is stored in an information storage region having added thereto identification information identical or related to the published information.

According to the layout system thus constructed, the layout device stores the published information in the information storage region having added thereto identification information identical or related thereto, but when the pieces of identification information are similar, determines the allowable range on the basis of the similarity of the arrangement control information.

Further, an eleventh aspect of the invention provides the layout system according to the tenth aspect of the invention, such that when there is no published information having added thereto identification information identical or related to that added to an information storage region as a target to be stored, in the published information storage device, the layout device is adapted to select from the published information storage device published information having added thereto the identification information whose similarity to the identification information added to the information storage region as a target to be stored is greater than that of the arrangement control information added to the information storage region as a target to be stored, and to store the selected published information in the information storage region as a target to be stored.

According to the layout system thus constructed, if there is no published information having added thereto identification information identical or related to that added to an information storage region as a target to be stored, in the published information storage device, the layout device selects from the published information storage device the published information having added thereto the identification information whose similarity to the identification information added to the information storage region as a target to be stored is greater than that of the arrangement control information added to the information storage region as a target to be stored, and stores the selected published information in the information storage region as a target to be stored.

Further, a twelfth aspect of the invention provides the layout system according to the tenth aspect of the invention, such that when there is no information storage region having added thereto identification information identical or related to that added to the published information as a target to be stored, in the layout region, the layout device is adapted to select from the layout region the information storage region having added thereto the identification information whose similarity to the identification information added to the published information as a target to be stored is greater than that of the arrangement control information added to the published information as a target to be stored, and to store in the selected information storage region the published information as a target to be stored.

According to the layout system thus constructed, if there is no information storage region having added thereto identification information identical or related to that added to the published information as a target to be stored, in the layout region, the layout device selects from the layout region the information storage region having added thereto the identification information whose similarity to the identification information added to the published information as a target to be stored is greater than that of the arrangement control information added to the published information as a target to be stored, and stores in the selected information storage region the published information as a target to be stored.

Further, a thirteenth aspect of the invention provides the layout system according to any one of the tenth to twelfth aspects of the invention, such that the similarity is a value according to the distance between the pieces of identification information in a word system when the meanings of words given as the identification information are systemized.

According to the layout system thus constructed, the similarity of the arrangement control information is set as a value according to the distance between the pieces of identification information in a word system when the meanings of words given as the identification information are systemized. Therefore, if the pieces of identification information are similar when the published information are stored in the information storage region having added thereto identification information identical or related thereto, the layout device determines the allowable range on the basis of the distance between the pieces of identification information in the word system.

Further, a fourteenth aspect of the invention provides the layout system according to any one of the fourth to thirteenth aspects of the invention, such that when there is, in the layout region, an information storage region where the published information cannot be stored by any one of the above techniques, the layout device is adapted to delete the relevant information storage region.

According to the layout system thus constructed, if there is, in the layout region, an information storage region where the published information cannot be stored by any one of the above techniques, the layout device deletes the information storage region.

Further, a fifteenth aspect of the invention provides the layout system according to any one of the fourth to thirteenth aspects of the inventions, such that when there is, in the layout region, an information storage region where the published information cannot be stored by any one of the above techniques, the layout device is adapted to store margin-filling information in the relevant information storage region.

According to the layout system thus constructed, if there is, in the layout region, an information storage region where the published information cannot be stored by any one of the above techniques, the layout device stores margin-filling information in the information storage region.

In the above case, the margin-filling information includes, for example, image information showing pictures, illustrations or other images, advertisement information, or coupon information.

Further, a sixteenth aspect of the invention provides the layout system according to any one of the fourth to fifteenth aspects of the invention, further including a identification-information adding device to add the identification information to the published information.

The identification-information adding device is adapted to analyze the contents of the published information and to add the identification information to the published information on the basis of the analysis results.

In the layout system thus constructed, the identification-information adding device analyzes the contents of the published information and adds the identification information to the published information on the basis of the analysis results.

Further, a seventeenth aspect of the invention provides the layout system according to any one of the fourth to sixteenth aspects of the invention, such that the published information has added thereto a plurality of pieces of the identification information having priority.

When identification information having a predetermined level of priority, among the identification information added to the published information is taken as a target and it is determined that there is no published information having added thereto identification information identical or related to that added to an information storage region as a target to be stored, in the published information storage device, the layout device is adapted to take as target identification information having a priority one level lower than the predetermined level of priority, among the identification information added to the published information, and to select from the published information storage device the published information having added thereto identification information identical or related to that added to the information storage region as a target to be stored.

According to the layout system thus constructed, if identification information having a predetermined level of priority, among the identification information added to the published information is taken as a target and it is determined that there is no published information having added thereto identification information identical or related to that added to an information storage region as a target to be stored, in the published information storage device, the layout device takes as target identification information having a priority one level lower than the predetermined level of priority, among the identification information added to the published information and selects the published information having added thereto identification information identical or related to that added to an information storage region as a target to be stored, from the published information storage device.

Further, an eighteenth aspect of the invention provides the layout system according to any one of the fourth to seventeenth aspects of the inventions, such that the information storage region has added thereto a plurality of pieces of the identification information having priority.

When identification information having a predetermined level of priority, among the identification information added to the information storage regions is taken as a target and it is determined that there is no information storage region having added thereto identification information identical or related to that added to published information as a target to be stored, in the layout region, the layout device is adapted to take as target identification information having a priority one level lower than the predetermined level of priority, among the identification information added to the information storage regions, and to select from the layout region an information storage region having added thereto identification information identical or related to that added to the published information as a target to be stored.

According to the layout system thus constructed, if identification information having a predetermined level of priority, among the identification information added to the information storage regions is taken as a target and it is determined that there is no information storage region having added thereto identification information identical or related to that added to published information as a target to be stored, in the layout region, the layout device takes as target identification information having a priority one level lower than the predetermined level of priority, among the identification information added to the information storage regions, and selects from the layout region an information storage region having added thereto identification information identical or related to that added to the published information as a target to be stored.

Further, a nineteenth aspect of the invention provides the layout system according to any one of the fourth to eighteenth aspects of the invention, further including a user information storage device to store user information regarding a user. The layout device is adapted to select published information from the published information storage device on the basis of the user information in the user information storage device.

According to the layout system thus constructed, the layout device selects the published information from the published information storage device on the basis of the user information in the user information storage device.

In the above case, the user information, for example, includes user's age, sex, interest, favor, address or name or a computer capacity of a user terminal. Hereinafter, this is also applicable to the layout system in the twentieth aspect of the invention.

Further, the user information storage device stores the user's information all the time with every device. The user information may be previously storied or may be stored by external input or the like when the present system is in operation, without any prior storing step. Hereinafter, this is also applicable to the layout system in the twentieth aspect of the invention.

Further, a twentieth aspect of the invention provides the layout system according to any one of the fourth to eighteenth aspects of the invention, further including a user information storage device to store user information regarding a user. The layout device is adapted to make a layout for the published information on the basis of the user information in the user information storage device.

According to the layout system thus constructed, the layout device makes a layout for the published information on the basis of the user information in the user information storage device.

In the above case, the layout is made on the basis of the user information. It may be considered that if age is included in the user information, and if the user is relatively middle-aged, a layout having relatively large font size is adopted. Moreover, it may be considered that if sex is included in the user information, and if the user is a woman, a layout having a round letter font is adopted. In addition, it may be considered that if an interest or favor is included in the user information, a layout for children magazine style, sports newspaper style or technical document style is adopted in accordance with the interest or favor. Further, it may be considered that if an address is included in the user information, a layout with a background showing an image of scenery specially made with the land designated by the address is adopted. Moreover, it may be considered that if a computer capacity of the user terminal is included in the user information, and if the use environment of RAM of the user terminal is small, a layout that hardly utilizes an image having a large data capacity is adopted.

On the other hand, in order to address or accomplish the above, a twenty-first aspect of the invention provides a layout program, including a layout program for selecting published information from a plurality of pieces of published information and for making a layout for the selected published information, the layout program performing a layout process by storing the selected published information in information storage regions arranged in a layout region.

Information storage regions and published information have respectively added thereto identification information to make the information storage regions and the published information correspond to each other, and the published information has added thereto arrangement control information to control the arrangement in the information storage regions.

When there is no information storage region or published information suitable to store the published information in the information storage regions on the basis of the identification information, the layout program is adapted to store the published information in the information storage regions on the basis of the arrangement control information.

According to the layout program thus constructed, if a computer reads the program and then performs a process according to the read program, it is possible to achieve the same effect as that of the layout system in the first aspect of the invention.

Further, a twenty-second aspect of the invention provides a layout program, including: a published information storage program for storing a plurality of pieces of published information; and a layout program for selecting the published information from the published information storage program and for making a layout for the selected published information, the layout program performing a layout process by storing the selected published information in information storage regions arranged in a layout region.

The information storage regions and the published information have respectively added thereto identification information to make the information storage regions and the published information correspond to each other, and the published information has added thereto arrangement control information to control the arrangement in the information storage regions.

The layout program is adapted to determine whether there are an information storage region and published information having added thereto identical or related identification information by comparing the identification information added to the published information with that added to the information storage regions, and then, when there are an information storage region and published information having added thereto identical or related identification information, the layout program is adapted to store relevant published information in the relevant information storage region, and when there is no information storage region and published information having added thereto identical or related identification information, the layout program is adapted to store the published information in the information storage regions on the basis of arrangement control information added to the relevant published information.

According to the layout program thus constructed, if a computer reads the program and then performs a process according to the read program, it is possible to achieve the same effect as that of the layout system in the second aspect of the invention.

Further, a twenty-third aspect of the invention provides a layout program, including:

a layout program for selecting published information from a plurality of pieces of published information and for making a layout for the selected published information, the layout program performing a layout process by storing the selected published information in information storage regions arranged in a layout region.

The information storage regions and the published information have respectively added thereto identification information to make the information storage regions and the published information correspond to each other, and arrangement control information to control the arrangement in the information storage regions.

When there is no information storage region or published information suitable to store the published information in the information storage regions on the basis of the identification information, the layout program is adapted to store the published information in the information storage regions on the basis of the arrangement control information.

According to the layout program thus constructed, if a computer reads the program and then performs a process according to the read program, it is possible to achieve the same effect as that of the layout system in the third aspect of the invention.

Further, a twenty-fourth aspect of the invention provides a layout program, including: a published information storage program for storing a plurality of pieces of published information; and a layout program for selecting the published information from the published information storage program and for making a layout for the selected published information, the layout program performing a layout process by storing the selected published information in information storage regions arranged in a layout region.

The information storage regions and the published information have respectively added thereto identification information to make the information storage regions and the published information correspond to each other, and arrangement control information to control the arrangement in the information storage regions.

The layout program is adapted to determine whether there are an information storage region and published information having added thereto identical or related identification information by comparing the identification information added to the published information with that added to the information storage regions, and then, when there are an information storage region and published information having added thereto identical or related identification information, the layout program is adapted to store relevant published information in the relevant information storage region, and when there is no information storage region and published information having added thereto identical or related identification information, the layout program is adapted to store the published information in the information storage regions on the basis of arrangement control information added to the relevant information storage regions and published information.

According to the layout program thus constructed, if a computer reads the program and then performs a process according to the read program, it is possible to achieve the same effect as that of the layout system in the fourth aspect of the invention.

On the other hand, in order to address or accomplish the above, a twenty-fifth aspect of the invention provides a layout method, including: selecting published information from a plurality of pieces of published information; and making a layout for the selected published information, the layout being performed by storing the selected published information in the information storage regions arranged in a layout region.

The information storage regions and the published information have respectively added thereto identification information to make the information storage regions and the published information correspond to each other, and the published information has added thereto arrangement control information to control the arrangement in the information storage regions.

When there is no information storage region or published information suitable to store the published information in the information storage regions on the basis of the identification information, the layout stores the published information in the information storage region on the basis of the arrangement control information.

Further, a twenty-sixth aspect of the invention provides a layout method, including: selecting published information from a published information storage device to store a plurality of pieces of published information and of making a layout for the selected published information, the layout being performed by storing the selected published information in information storage regions arranged in a layout region.

The information storage regions and the published information have respectively added thereto identification information to make the information storage regions and the published information correspond to each other, and the published information has added thereto arrangement control information to control the arrangement in the information storage regions.

The layout determines whether there are an information storage region and published information having added thereto identical or related identification information by comparing the identification information added to the published information with that added to the information storage regions, and then, when there are an information storage region and published information having added thereto identical or related identification information, the layout stores the published information in the information storage regions, and when there is no information storage region and published information having added thereto identical or related identification information, the layout stores the published information in the information storage regions on the basis of arrangement control information added to the relevant published information.

Further, a twenty-seventh aspect of the invention provides a layout method, including: selecting published information from a plurality of pieces of published information and of making a layout for the selected published information, the layout being performed by storing the selected published information in the information storage regions arranged in a layout region.

The information storage regions and the published information have respectively added thereto identification information to make the information storage regions and the published information correspond to each other, and arrangement control information to control the arrangement in the information storage regions.

When there is no information storage region and published information suitable to store the published information in the information storage regions on the basis of the identification information, the layout stores the published information in the information storage region on the basis of the arrangement control information.

Further, a twenty-eighth aspect of the invention provides a layout method, including: selecting from a published information from published information storage device to store a plurality of pieces of published information and of making a layout for the selected published information, the layout being performed by storing the selected published information in the information storage regions arranged in a layout region,

The information storage regions and the published information have respectively added thereto identification information to make the information storage regions and the published information correspond to each other, and arrangement control information to control the arrangement in the information storage regions.

The layout determines whether there are an information storage region and published information having added thereto identical or related identification information by comparing the identification information added to the published information with that added to the information storage regions, and then, when there are an information storage region and published information having added thereto identical or related identification information, the layout stores the published information in the information storage regions, and when there is no information storage region and published information having added thereto identical or related identification information, the layout stores the published information in the information storage regions on the basis of the arrangement control information added to the information storage region and the published information.

### BRIEF DESCRIPTION OF THE DRAWINGS

FIG. 1 is a schematic illustrating the construction of a network system to which the present invention is applied;

FIG. 2 is a schematic illustrating the functional outline of a content distribution terminal 100;

FIG. 3 is a schematic illustrating the construction of the content distribution terminal 100;

FIG. 4 is a chart that illustrates the data structure of a user profile table 300;

FIGS. 5(a) and 5(b) is a schematic and a chart that illustrate the data structure of a layout definition file and layout number corresponding table 330;

FIG. 6 is a schematic that illustrates a part of the data structure of a layout definition file;

FIG. 7 is a schematic that illustrates the data structure of a layout frame;

FIGS. 8(a) and 8(b) is a schematic and a chart that illustrate the data structure of digital contents and a category number corresponding table 340;

FIG. 9 is a schematic that illustrates the data structure of article information;

FIG. 10 is a flowchart illustrating a user registration process;

FIG. 11 is a flowchart illustrating a content distribution process;

FIG. 12 is a flowchart illustrating an automatic layout process;

FIG. 13 is a flowchart illustrating a storage process to a layout frame of step S312;

FIG. 14 is a schematic that illustrates an article storage process;

FIG. 15 is a schematic that illustrates an article storage process;

FIG. 16 is a schematic that illustrates an article storage process;

FIG. 17 is a schematic that illustrates an article storage process;

FIG. 18 is a schematic that illustrates the data structure of article information;

FIG. 19 is a schematic that illustrates a word system when meanings of the words given as identification information are systemized;

FIG. 20 is a flowchart illustrating a storage process to a layout frame of step S312.

### DETAILED DESCRIPTION OF PREFERRED EMBODIMENTS

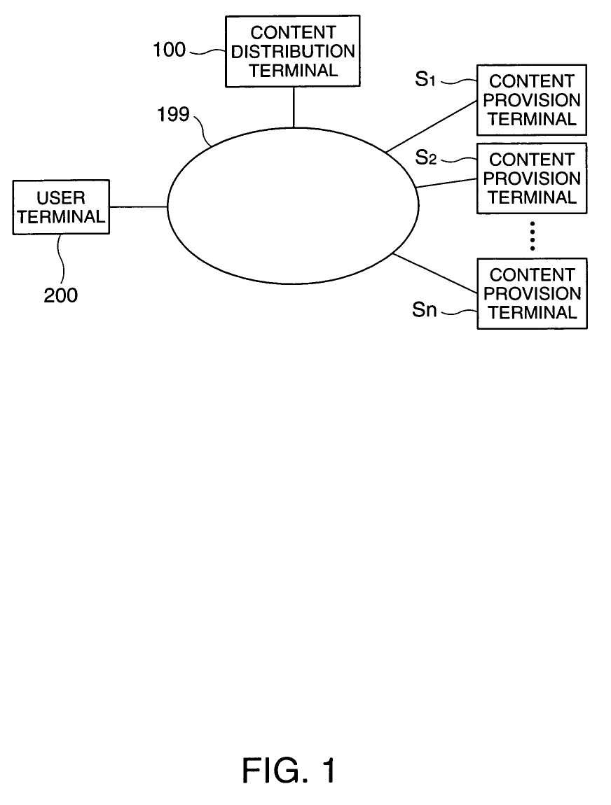

Hereinafter, a first exemplary embodiment of the present invention is described below with reference to accompanying drawings. FIGS. 1 to 17 illustrate a layout system, a layout program and a layout method according to the first exemplary embodiment of the present invention.

In this exemplary embodiment, the layout system, layout program and layout method according to the present invention, as shown in FIG. 1, are applied to the case that digital contents, such as news articles, are distributed to a user terminal 200 in a content distribution terminal 100.

First, the construction of a network system to which the present invention is applied is described with reference to FIG. 1. FIG. 1 is a schematic illustrating the construction of a network system according to the present invention.

Connected to an internet 199, as shown in FIG. 1, are a plurality of digital content provision terminals S₁ to Sₙ to provide digital contents, a content distribution terminal 100 to collect, store and distribute digital contents (hereinafter article information or articles for the digital contents provided from the content provision terminals S₁ to Sₙ) provided from the content provision terminals S₁ to Sₙ, and a user terminal 200 provided for users. Moreover, in order to facilitate the understanding of the present invention, only a single user terminal 200 is illustrated, but actually a plurality of user terminals may be connected to the internet 199.

The content provision terminals S₁ to Sₙ are constructed to have the same functions as a general computer in which CPU, ROM, RAM, I/F, and the like are bus-connected, and adapted to, when digital contents have been made, add to the digital contents a category number to specify a category of the digital contents, and then to transmit the digital contents to the content distribution terminal 100. The category number will be described in further detail below.

The user terminal 200 is constructed to have the same functions as a general computer in which CPU, ROM, RAM, I/F, or the like are bus-connection with, and it also has a world wide web (www) browser to access to the content distribution terminal 100 via the www browser.

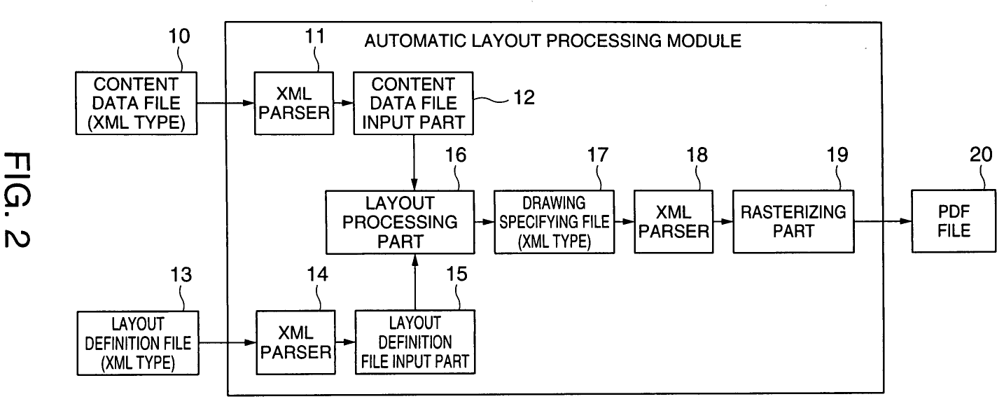

Next, the functional outline of the content distribution terminal 100 is described in detail with reference to FIG. 2. FIG. 2 is a schematic illustrating the functional outline of the content distribution terminal 100.

The content distribution terminal 100, as shown in FIG. 2, includes an extensible Markup Language (XML) parser 11 to analyze an XML type content data file 10, a content data file input part 12 to input the content data file 10 analyzed by the XML parser 11, an XML parser 14 to analyze an XML type layout definition file 13, a layout definition file input part 15 to input the layout definition file 13 analyzed by the XML parser 14, a layout processing part 16 to make a layout on the basis of the content data file 10 and layout definition file 13 inputted by the input parts 12 and 15, an XML parser 18 to analyze an XML type drawing specifying file 17 from the layout processing part 16, and a rasterizing part 19 to make up a Portable Document Format (PDF) type file 20 by performing a drawing on the basis of the drawing specifying file 17 analyzed by the XML parser 18. This exemplary embodiment includes, in particular, the layout processing part 16 among the aforementioned constitutional elements.

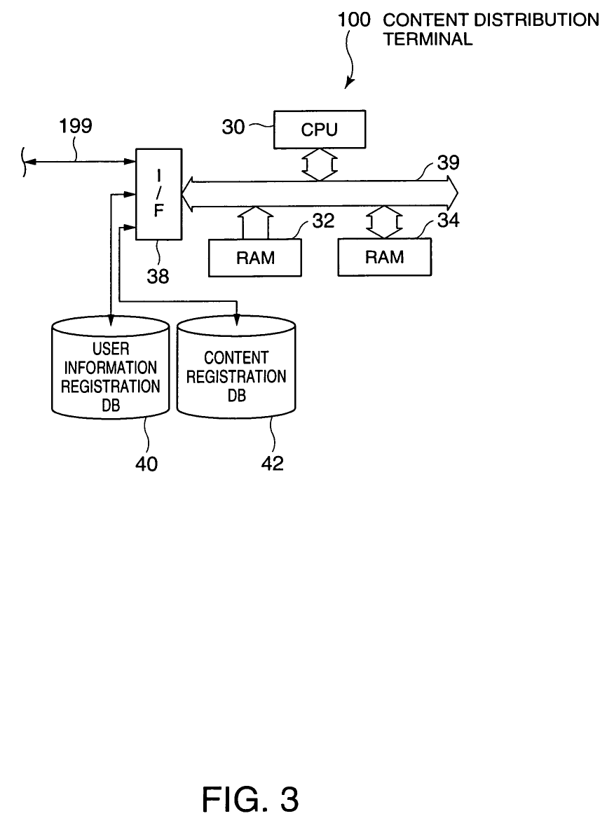

Next, the construction of the content distribution terminal 100 is described in detail with reference to FIG. 3. FIG. 3 is a schematic illustrating the construction of the content distribution terminal 100.

The content distribution terminal 100, as shown in FIG. 3, includes a CPU 30 to compute on the basis of a control program and control the whole system, a ROM 32 to keep a control program or the like of the CPU 30 previously stored in a predetermined region, a RAM 34 to store the data read from the ROM 32 or the like or the results of computation necessary for the computation processes of the CPU 30 and an I/F 38 to mediate the input/output of data to external devices. These units are connected to mutually transmit and receive data via a bus 39, a signal line for the transmission of data.

Connected to the I/F 38 are, as external devices, a user information registration DB 40 to register user information, a content registration DB 42 to collect and store the digital contents provided by the content provision terminals S₁ to Sₙ, and a signal line to make a connection to the internet 199.

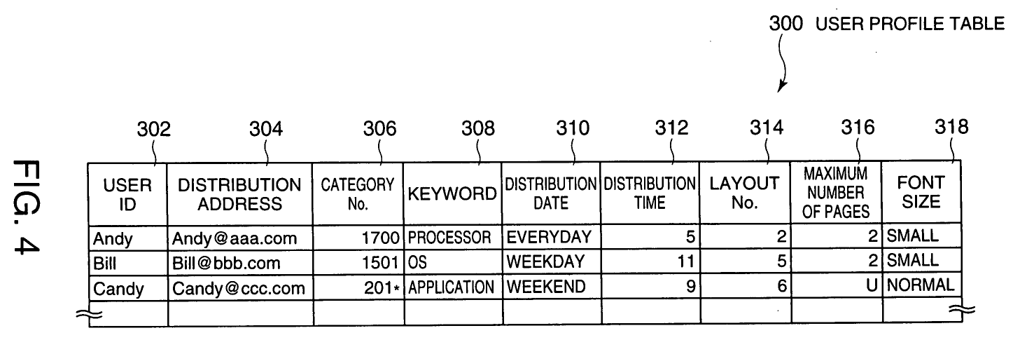

Next, the data structure of the user information registration DB 40 is described with reference to FIG. 4.

In the user information registration DB 40, as shown in FIG. 4, a user profile table 300 to register the user information is stored. FIG. 4 illustrates the data structure of the user profile table 300.

The user profile table 300, as shown in FIG. 4, is adapted to be capable of registering one or more records for each user. Each record includes a field 302 to register a user ID to specify a user, a field 304 to register a distribution address of digital contents, a field 306 to register a category number, a field 308 to register a keyword, a field 310 to register a distribution date, a field 312 to register a distribution time, a field 314 to register a layout number, a field 316 to register the maximum number of pages and a field 318 to register the font size.

In the field 308, a user-designated-keyword is registered when the digital contents including the keyword is selected as an object to be distributed. The keyword, for example, is given as a keyword that is frequently shown in the article of a category in which the user is interested. In FIG. 4, a “processor” and “operating system (OS)” are respectively registered at the first and second steps of the field 308.

In the field 310, a distribution date, when the user wants the digital contents to be distributed, is registered. For example, “everyday” is designated as a distribution date if the user wants the digital contents to be distributed everyday. If “weekday” only is desired as the distribution date, “weekday” is designated as the distribution date. If “weekend” only is desired as the distribution date, “weekend” is designated as the distribution date. In FIG. 4, “everyday” and “weekday” are respectively registered at the first and second steps of the field 310.

In the field 312, a distribution time when the user wants the digital contents to be distributed at a date designated by the user is registered. For example, several points of time are designated as a distribution time when one day is represented by a 24-hour system from midnight to 23 o'clock. In FIG. 4, “5 o'clock” and “11 o'clock” are respectively registered at the first and second steps of the field 312.

In the field 314, a layout number is registered to specify an output layout for digital contents. For example, the layout number is designated as a layout number to specify the output layout that the user wants. In the example of FIG. 4, layout No. 2 and layout No. 5 are respectively registered at the first and second steps of the field 314. Further, layout numbers are described in detail below.

In the field 316, the maximum number of pages will be registered as an upper limit when the digital contents are displayed or printed. Except when the maximum number of pages, for example, is designated as the maximum number of pages as an upper limit, it may be designated as a symbol of “u” indicating that the upper limit is not set. In the example of FIG. 4, “2 pages” and “u” are respectively registered at the first and third steps of the field 316.

In the field 318, a font size is registered when digital contents are displayed or printed. In the example of FIG. 4, ‘small’ and “normal” are respectively registered at the first and third steps of the field 318.

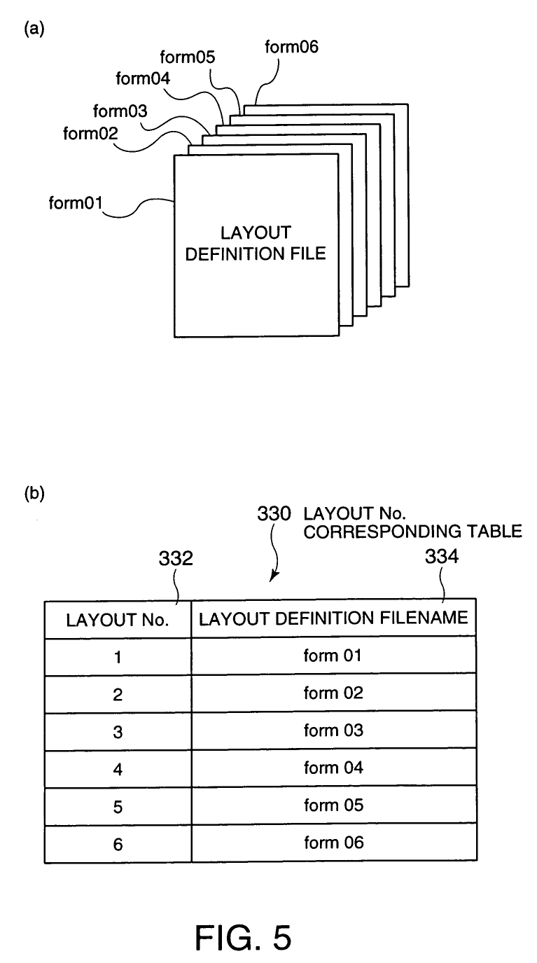

Further, in the user information registration DB 40, as shown in FIGS. 5(a) and 5(b), a plurality of layout definition files form 01 to form 06, regulates the output layout for digital contents, and a layout number corresponding table 330, which shows a correspondence relationship between the layout definition files form 01 to form 06, and the layout numbers are stored. FIGS. 5(a) and 5(b) illustrate the data structure of the layout definition files and layout number corresponding table 330.

The layout definition files form 01 to form 06, for example, define the layout frames for storing character information, the image size included in the digital contents, the arrangement position inside region of printing paper, the font size, the type and color of character information, the character interval or row pitch and the number, quality, size or ratio of image, and the layout definition files are described by XML or the like.

In the layout number corresponding table 330, as shown in FIG. 5(b), each record is registered at each layout number. Each record includes a field 332 having a registration for the layout number and a field 334 having registration of a filename of the layout definition files. In the example of FIG. 5(b), “1” as a layout number and “form 01” as a layout definition filename are respectively registered at the first step of record, while “2” as a layout number and “form 02” as a layout definition filename are respectively registered at the second step of record.

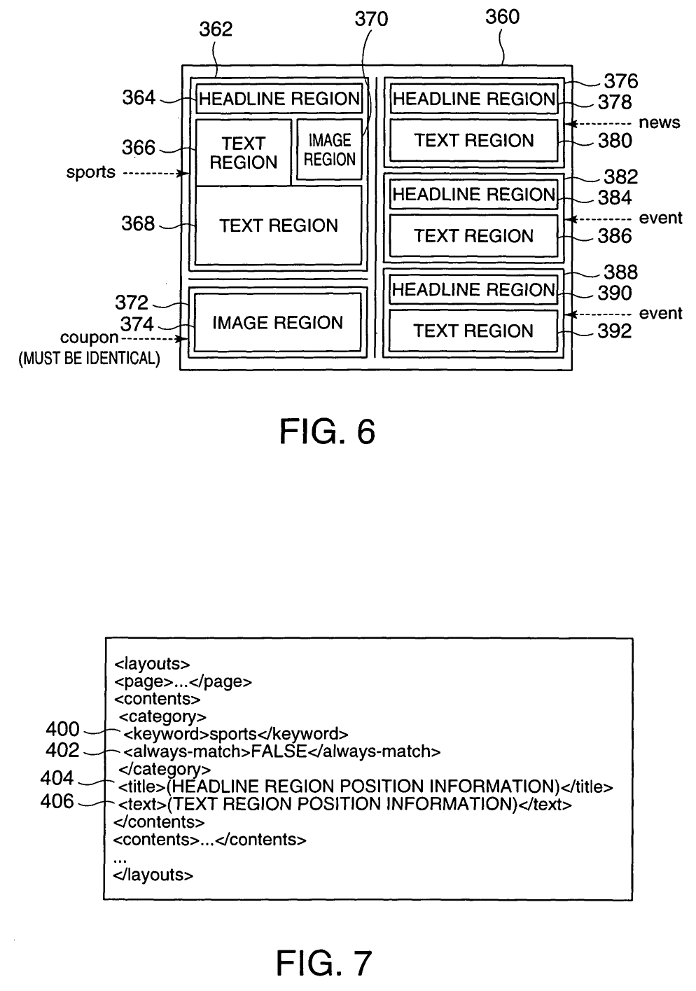

Next, the data structure of the layout definition files form 01 to form 06 is described in detail with reference to FIG. 6. FIG. 6 illustrates a part of the data structure of the layout definition file. Moreover, each of the layout definition files form 01 to form 06 is constructed with a different data structure. However, only a typical data structure of the layout definition files form 01 to form 06 is selected for description below.

The layout definition file form 01 includes a layout region 360 in each page. As shown in FIG. 6, the layout region 360 is constructed by arranging, for example, a layout frame 362 composed of a headline character information storage region 364, text character information storage regions 366 and 368 and an image information storage region 370; a layout frame 372 composed of an image information storage region 374; a layout frame 376 composed of a headline character information storage region 378 and a text character information storage region 380; a layout frame 382 composed of a headline character information storage region 384 and a text character information storage region 386; and a layout frame 388 composed of a headline character information storage region 390 and a text character information storage region 392.

The layout frame, as shown in FIG. 7, is adapted to set each item with a tag set of a starting tag and a finishing tag between a predetermined starting tag (for example, <contents>) and a predetermined finishing tag (for example, </contents>). FIG. 7 illustrates the data structure of a layout frame.

In the layout frame, a tag set 400 to set identification information to make a correspondence between the layout frame and article information, a tag set 402 to set arrangement control information to control the arrangement thereof in the layout frame, a tag set 404 to set a headline character information storage region and a tag set 406 to set a text character information storage region are described. In the example of FIG. 7, only one piece of identification information is set. However, a plurality of pieces of identification information can be added to the layout frame along with priority thereof. In the case of enclosure of a plurality of pieces of identification information, the earlier described identification information is set to get the higher level of priority. Similarly, the identification information and arrangement control information are also added to the article information, which is described below.

The arrangement control information is adapted to be capable of setting either “must be identical” (“true” in the example illustrated in FIG. 7) indicating that article information should be stored in a layout frame having added thereto identification information identical thereto or “may be different” (“false” in the example illustrated of FIG. 7) indicating that the article information may be stored in a layout frame other than the one having added thereto the identification information identical thereto.

In the example of FIG. 6, the layout frame 362 has added thereto “sports” as identification information, the layout frame 372 has added thereto “coupon” as identification information, the layout frame 376 has added thereto “news” as identification information, and the layout frames 382 and 388 have added thereto “event” as identification information. Moreover, the layout frames 362, 376, 382 and 388 have added thereto “may be different” as arrangement control information, while the layout frame 372 has added thereto “must be identical” as arrangement control information.

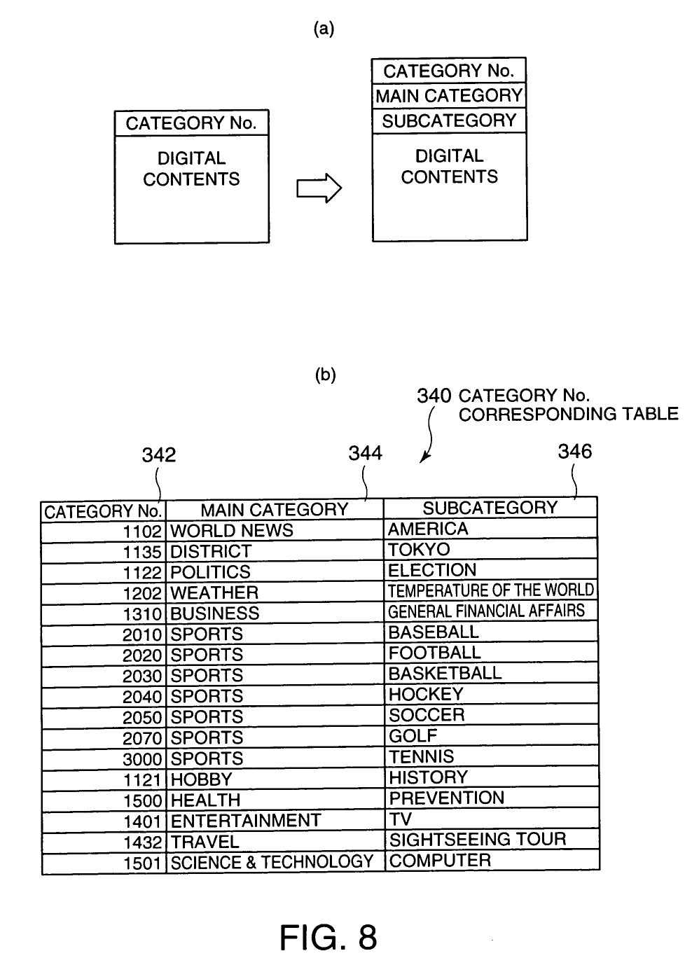

Next, the data structure of the content registration DB 42 is described in detail with reference to FIGS. 8(a) and 8(b).

The content registration DB 42, as shown in FIGS. 8(a) and 8(a), stores digital contents provided from the content provision terminals S₁ to Sₙ, and a category corresponding table 340 showing the correspondence relationship between category number, and main category and subcategory. FIGS. 8(a) and 8(b) illustrates the data structure of digital contents, category number corresponding table 340.

The digital contents provided from the content provision terminals S₁ to Sₙ, as shown in FIG. 8(a), have added thereto article numbers and category numbers. A content distribution terminal 100 classifies digital contents into respective categories and registers them in the content registration DB 42. With reference to the category numbers corresponding table 340, the main category and subcategory are further added to the digital contents for registration in addition to the article numbers and category numbers. Further, the digital contents are composed of an article including title information indicating a title of the article, image information regarding the image of the article and character information regarding the sentences of the article.

In the category number corresponding table 340, as shown in FIG. 8(b), one record is registered for individual main category and subcategory. Each record consists of a field 342 with the registration of the category number, a field 344 with the registration of the main category and a field 346 with the registration of the subcategory. In the example of FIG. 8(b), “1102” as the category number, ‘world news’ as the main category and “America” as the subcategory are respectively registered at the first step of the record, while “2010” as the category number, “sports” as the main category and “baseball” as the subcategory are respectively registered in the sixth step of the record.

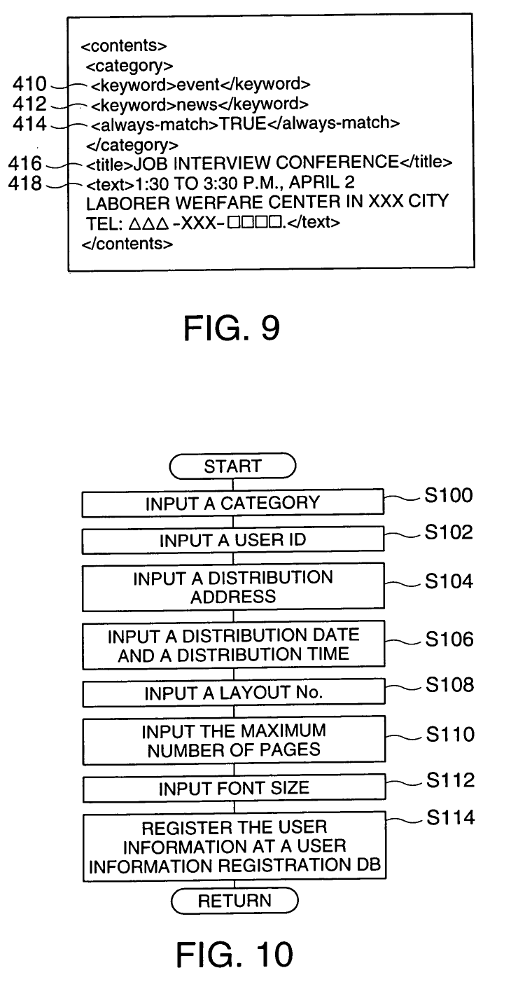

As shown in FIG. 9, the article information is made to set respective items with a tag set of a starting tag and a finishing tag between a predetermined starting tag (for example, <contents>) and a predetermined finishing tag (for example, </contents>). FIG. 9 illustrates the data structure of article information.

In the article information, tag sets 410 and 412 to set identification information, a tag set 414 to set arrangement control information, a tag set 416 to set headline character information and a tag set 418 to set text character information are described. In the example of FIG. 9, only two pieces of identification information are set in the layout frame. However, a plurality of pieces of identification information may be further added to the layout frame along with priority thereof. In the case of enclosure of a plurality of pieces of identification information, the earlier described identification information is set to get the higher level of priority.

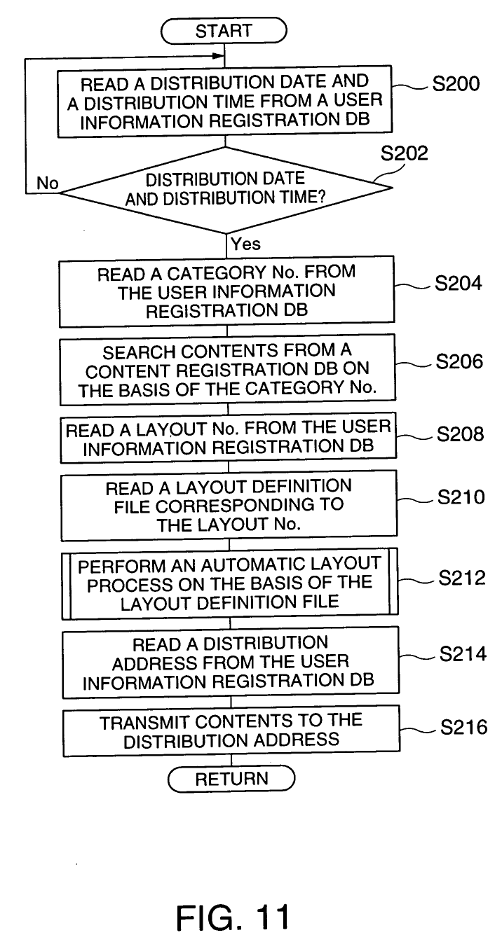

The construction of a CPU 30 and a process executed by the CPU 30 is described with reference to FIGS. 10 and 11.

A CPU 30 is composed of a micro-processing unit MPU or the like, operates a predetermined program stored in a predetermined region of ROM 32, and the CPU is adapted to perform a user registration process and a content distribution process, respectively, as shown in the flowcharts of FIGS. 10, 11 in a time-sharing way according to the program.

First, the user registration process is described in detail with reference to FIG. 10. FIG. 10 is a flowchart illustrating the user registration process.

The user registration process includes the requirements of inputting the necessary user information such as the ID of a user who has made access and of registering the inputted user information at the user profile table 300. If the process is performed in the CPU 30, the flow proceeds to a step S100 as shown in FIG. 10. Further, hereinafter, all the inputs are made at each step by interactive communication with the user.

In step S100, a main category and a subcategory are inputted, and the flow proceeds to step S102 where the user ID and a password are inputted. Next, the flow proceeds to step S104 where a distribution address is inputted, and to step S106 where a distribution date and a distribution time are inputted. Next, the flow proceeds to step S108.

In step S108, a layout number is inputted, and the flow proceeds to step S110 where the maximum number of pages is inputted. Next, the flow proceeds to step S112 where a font size is inputted. Next, the flow proceeds to step S114 where the user information inputted in steps S110 to S112 is registered at the user profile table 300. A series of steps in the process are then finished, and the flow returns to the original processing step.

Next, a content distribution process is described in detail with reference to FIG. 11. FIG. 11 is a flowchart illustrating the content distribution process.

The content distribution process is a process to provide digital contents for a user terminal 200 with reference to the user profile table 300. First, if the CPU 300 performs the process, the flow proceeds to step S200 as shown in FIG. 11. Further, hereinafter, all the steps in the process are operated for one record of the user profile table 300. In practice, the steps in the process is performed by as many as the number of the records registered at the user profile table 300.

In step S200, a distribution date and a distribution time are read from the user profile table 300. The flow proceeds to step S202 where it is determined whether it is the date and time for the digital contents to be distributed on the basis of the read distribution date and distribution time. If it is determined that it is the date and time for the digital contents to be distributed (Yes), the flow proceeds to step S204. However, if it is determined that it is not the date and time for the digital contents to be distributed (No), the flow proceeds to step S200.

In step S204, a category number is read from the user profile table 300. The flow proceeds to step S206 where the digital contents of the content registration DB 42 is searched on the basis of the read category number and the digital contents having added thereto the category number identical to the read category number is searched out. The flow proceeds to step S208.

In step S208, a layout number is read from the user profile table 300. The flow proceeds to step S210 where a layout definition file corresponding to the read layout number is read from the user information registration DB 40 with reference to the layout number corresponding table 330. The flow proceeds to step S212 where an output layout for the digital contents searched out in step S206 is determined on the basis of the read layout definition file and an automatic layout process is performed to make up the digital contents to be provided. Next, the flow proceeds to step S214.

In step S214, a distribution address is read from the user profile table 300. The flow proceeds to step S216 where the made-up digital contents for provision are distributed to the read distribution address. A series of steps in the process are finished and the flow returns to the original processing step.

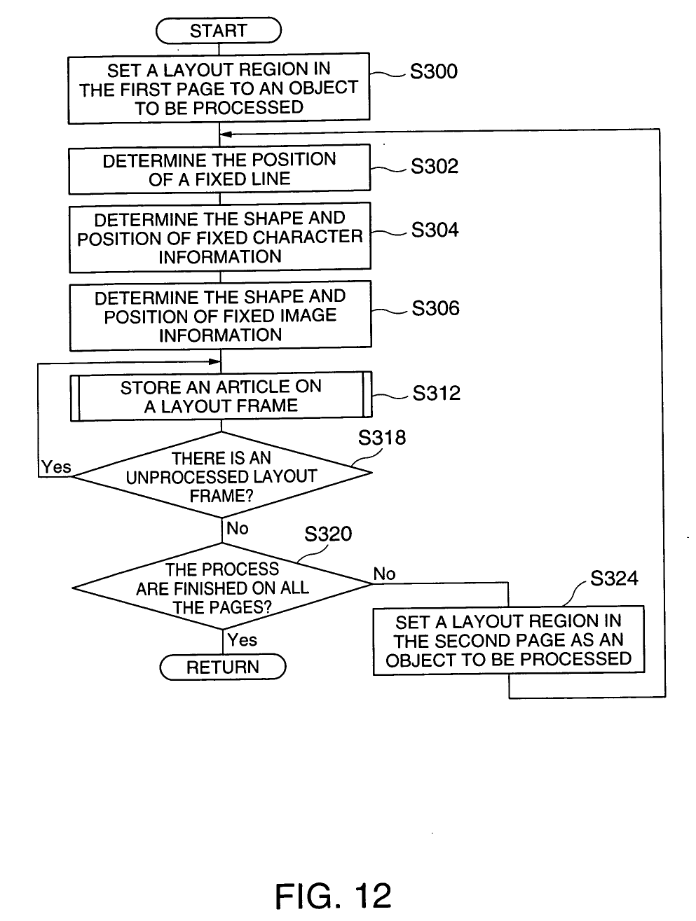

Next, the automatic layout process in step S212 is described in detail with reference to FIG. 12. FIG. 12 is a flowchart illustrating an automatic layout process.

After the automatic layout process is performed in step S212, the flow first proceeds to step S300 as shown in FIG. 12.

In step S300, a layout region in the first page among the layout regions 360 of the layout definition file read in step S210 is set as an object to be processed. Next, the flow proceeds to step S302 where a position of a fixed line that is fixedly arranged in the page is determined, then to step S304 where a shape and a position of fixed character information that is fixedly arranged in the page are determined, and then to step S306 where a shape and a position of fixed image information that is fixedly arranged in the page are determined. Next, the flow proceeds to step S312.

In step S312, an article to be arranged in the layout region 360 is selected from all the digital contents searched in step S206, the shape and position of the layout frame are determined on the basis of the selected article, and the selected article is stored in the layout frame. Next, the flow proceeds to step S318.

In step S318, it is determined whether there is an unprocessed layout frame in the layout region 360. If it is determined that there is no unprocessed layout frame (No), the flow proceeds to step S320 where it is determined whether steps S302 to 318 of the process are finished for all the pages of the layout definition file read in step S210. If it is determined that the steps in the process are finished for all the pages (Yes), a series of steps in the process are completed and the flow returns to the original processing step.

On the other hand, in step S320, if it is determined that the steps S302 to S318 are not performed on all the pages of the layout definition file read in step S210 (No), the flow proceeds to step S324 where a layout region in the second page among layout regions 360 of the layout definition file read in step S210 is set as an object to be processed. Next, the flow proceeds to step S302.

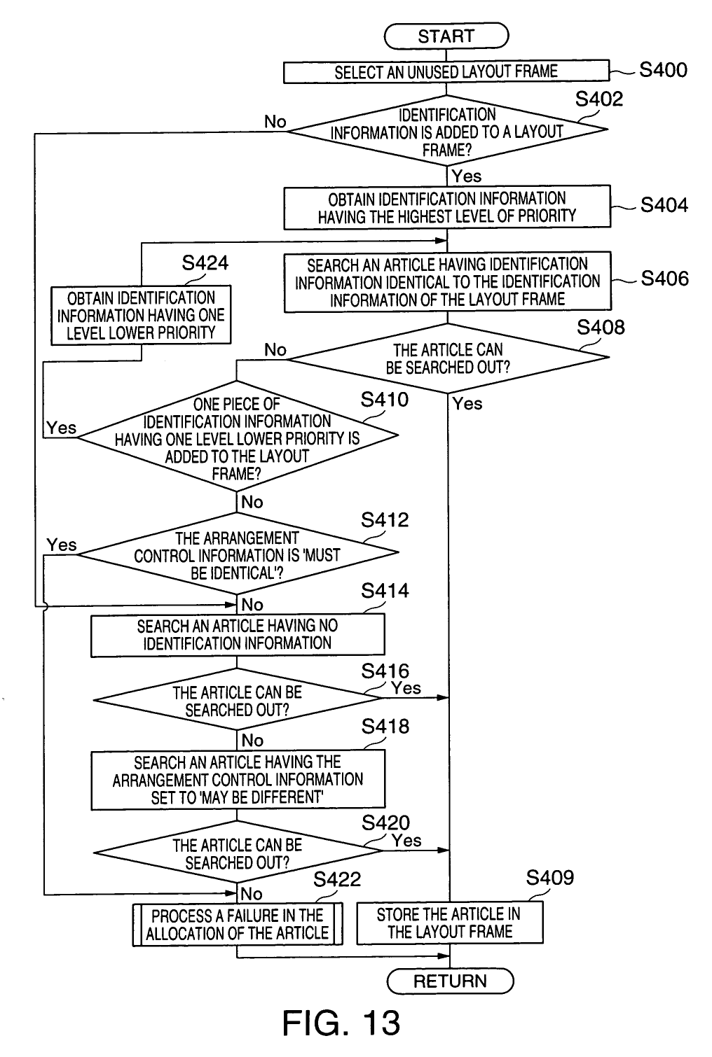

On the other hand, in step S318, if it is determined that there is an unprocessed layout frame in the layout region 360 (Yes), the flow proceeds to step S312. 10176 Next, a storage process in the layout frame in step S312 is described in detail with reference to FIG. 13. FIG. 13 is a flowchart illustrating a storage process in the layout frame in step S312.

The layout process in the layout frame is a process to store article information in the layout frame on the basis of identification information and arrangement control information. If the process is performed in step S316, the flow proceeds to step S400 as shown in FIG. 13.

In step S400, an unused layout frame storing no article information is selected from the present layout region 360 as a target to be stored. Next, the flow proceeds to step S402 where it is determined whether the identification information is added to the layout frame as a target to be stored. If it is determined that the identification information is added to the layout frame (Yes), the flow proceeds to step S404.

In step S404, identification information having the highest level of priority is obtained from all the pieces of the identification information added to the layout frame as a target to be stored. The flow proceeds to step S406 where an article having added thereto identification information identical to the identification information added to the layout frame as a target to be stored is searched from among the digital contents searched out in step S206. The flow proceeds to step S408 where it is determined whether the relevant article can be searched out by a searching operation. If it is determined that the relevant article can be searched out (Yes), the flow proceeds to step S409 where the searched-out article is stored in the layout frame as a target to be stored. A series of steps in the process are finished, and the flow returns to the original processing step.

On the other hand, in step S408, if it is determined that the relevant article cannot be searched out by the searching operation in step S406 (No), the flow proceeds to step S410 where it is determined whether one piece of identification information having one level lower priority is added to the layout frame as a target to be stored. If it is determined that the piece of identification information having the one level lower priority is not added to the layout frame (Yes), the flow proceeds to step S412.

In step S412, it is determined that the arrangement control information added to the layout region is “must be identical”. If it is determined that the arrangement control information is “must be identical” (Yes), a process to cope with the case that there is no suitable article is performed. A series of steps in the process are finished and the flow returns to the original processing step.

On the other hand, in step S412, if it is determined that the arrangement control information added to the layout region is “may be different” (No), the flow proceeds to step S414 where an article that does not have added thereto identification information is searched from among the digital contents searched out in step S206. Next, the flow proceeds to step S416 where it is determined whether the relevant article can be searched out by the searching operation. If it is determined that the article can be searched out (Yes), the flow proceeds to step S409.

On the other hand, in step S416, if it is determined that the relevant article cannot be searched out by the searching operation in step S414, the flow proceeds to step S418 where the article having the arrangement control information set to “may be different” is searched from among the digital contents searched out in step S206. Next, the flow proceeds to step S420 where it is determined whether the relevant article can be searched out by the searching operation. If it is determined that the relevant article can be searched out (Yes), the flow proceeds to step S409.

On the other hand, in step S420, if it is determined that the relevant article cannot be searched out by the searching operation of step S418 (No), the flow proceeds to step S422 where a process is performed to cope with the case that there is no suitable article. A series of steps in the process are finished, and the flow returns to the original processing step. Specifically, in step S422, the process is to delete the layout frame as a target to be stored or to store the margin contents of image information to show pictures, illustrations, or other images, advertisement information, coupon information or the like, in the layout frame as a target to be stored.

On the other hand, in step S410, if it is determined that the identification information having one level lower priority is added to the layout frame as a target to be stored (Yes), the flow proceeds to step S424 where the identification information having one level lower priority is obtained from the identification information added to the layout frame as a target to be stored. Next, the flow proceeds to step S406.

On the other hand, in step S402, if it is determined that the identification information is not added to the layout frame as a target to be stored (No), the flow proceeds to step S414.

Operations of the exemplary embodiments are described below.

First, a description is provided regarding of information needed to distribute digital contents. If a user wants the digital contents to be distributed, the user makes an access to the content distribution terminal 100 through the www browser in the user terminal 200 and inputs a user registration request.

At the user terminal 200, if the user registration request is inputted, the request to input all the necessary user information is available to the user through the communication with the content distribution terminal 100. At this time, in response to the inputting request, the user inputs the user information such as main category, subcategory, user ID, password, distribution address, distribution date, distribution time, layout number, maximum number of pages and font size. Next, the user information is transmitted to the content distribution terminal 100.

If the content distribution terminal 100 receives the user information along with the registration request, the user information is processed through steps S100 to S104 and registered at the user profile table 300.

A description is provided below with reference to the user profile table 300 regarding distribution of the digital contents.

If it falls on the distribution date of digital contents with reference to the user profile table 300, the content distribution terminal 100 operates steps S204, S206 to read the category number from the user profile table 300, to search the digital contents of content registration DB 42 on the basis of the read category number and to search out the digital contents having added thereto the category number identical to the read category number. Next, steps S208 to S212 are undertaken to read the layout number from the user profile table 300 and a layout definition file corresponding to the read layout number from the user information registration DB 40 with reference to the layout number corresponding table 330, to determine an output layout for the searched-out digital contents on the basis of the read layout definition file and to make up the digital contents to be provided.

In the course of the layout process, steps S300 to S306 are undertaken to determine the position of a fixed line, the shape and position of fixed character information and the shape and position of fixed image information in that sequence. Next, step S312 is repeated to perform an article storing process to store an article to a layout frame for the layout region 360 of respective pages.

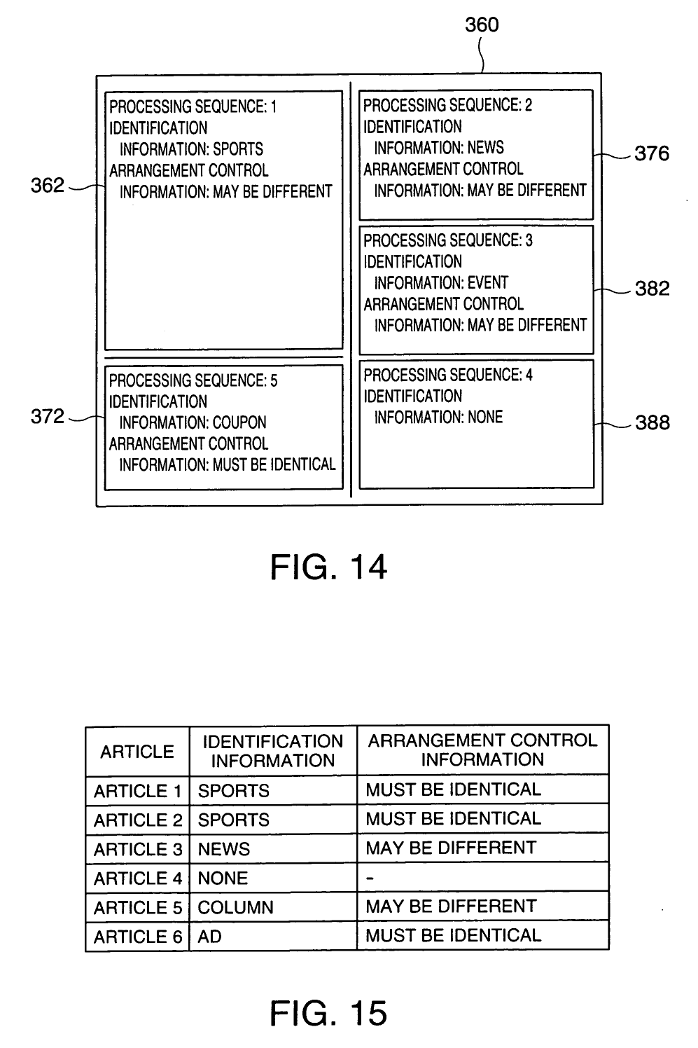

The article storing process will be described with reference to FIGS. 14 to 17. FIGS. 14 to 17 illustrate the article storing process.

For example, a description is provided regarding a case that an article shown in FIG. 15 is stored in the layout frames 362, 372, 376, 382 and 388 arranged in the layout region 360 shown in FIG. 14.

In the example of FIG. 14, the layout frame 362 has added thereto “sports” as identification information, the layout frame 372 has added thereto “coupon” as identification information, the layout frame 376 has added thereto “news” as identification information, and the layout frame 382 has added thereto “event” as identification information. Further, the layout frames 362, 376, 382 and 388 have added thereto “may be different” as arrangement control information, while the layout frame 372 has added thereto “must be identical” as arrangement control information. Moreover, the layout frames are selected in the sequence of layout frames 362, 376, 382, 388 and 372 in the layout region 360 of FIG. 14.

On the other hand, in the example of FIG. 15, articles 1 and 2 have added thereto “sports” as identification information, article 3 has added thereto “news” as identification information, article 5 has added thereto “column” as identification information, and article 6 has added thereto “ad” as identification information. Further, articles 1, 2 and 6 have added thereto “must be identical” as arrangement control information, while articles 3 and 5 have added thereto “may be different” as arrangement control information. Moreover, the articles are selected in the sequence of numbers added thereto, that is, the lower number comes earlier in the sequence.

When such layout frames and articles are taken as a target, step S400 is undertaken for the article storing process where the layout frame 362 is selected as a target to be stored, and it is determined whether identification information is added to the layout frame 362. Since the layout frame 362 has added thereto “sports” as identification information, steps S404 and S406 are undertaken to obtain “sports” having the highest level of priority from all the pieces of the identification information added to the layout frame 362 and to search an article having added thereto identification information “sports”. As the article 1 has added thereto “sports” as identification information, article 1 is searched out by the searching operation. If article 1 is searched out, step S409 is undertaken to store article 1 in the layout frame 362.

Next, the layout frame 376 is selected as a target to be stored. Since the layout frame 376 has added thereto “news” as identification information, an article having added thereto the identification information “news” is searched. As article 3 has added thereto “news” as identification information, article 3 is searched out by the searching operation. If article 3 is searched out, article 3 is stored in the layout frame 376.

Next, the layout frame 382 is selected as a target to be stored. As the layout frame 382 has added thereto “event” as identification information, an article having added thereto the identification information “event” is searched. However, since there is no article having added thereto the identification information “event” among the remaining articles 2, 4 to 6, it is impossible to search out the relevant article by the searching operation. Next, steps S410 to 414 are undertaken to search an article not having added thereto identification information. Since article 4 has not added thereto identification information, article 4 is searched out by the searching operation. If article 4 is searched out, article 4 is stored in the layout frame 382.

Next, the layout frame 388 is selected as a target to be stored. Since the layout frame 388 has not added thereto identification information, steps S402 and S414 are undertaken to search an article not having added thereto identification information. However, since there is no article not having added thereto identification information among the remaining articles 2, 5 and 6, the relevant article cannot be searched out by the searching operation. Then, steps S416 and S418 are undertaken to search an article having arrangement control information that is set to “may be different”. The arrangement control information added to article 5 is set to “may be different”, so that article 5 is searched out by the searching operation. If article 5 is searched out, article 5 is stored in the layout frame 388.

Next, the layout frame 372 is selected as a target to be stored. Since the layout frame 372 has added thereto “coupon” as identification information, an article having added thereto the identification information “coupon” is searched. However, since there is no article among the remaining articles 2 and 6 having added thereto the identification information “coupon”, the relevant article cannot be searched out by the searching operation. Next, an article not having added thereto identification information is searched. However, even in this case, since there is no article not having added thereto identification information among the remaining articles 2 and 6, the relevant article cannot be searched out by the searching operation. Next, an article having arrangement control information set to “may be different” is searched. However, still in this case, there is no article having arrangement control information set to “may be different” among the remaining articles 2 and 6, the relevant article cannot be searched out by the searching operation, so that steps S420 and S422 are undertaken to perform a process to cope with the case that there is no suitable article, for example, a process of storing margin contents in the layout frame 372.

Therefore, if an article shown in FIG. 15 is stored in layout frames 362, 372, 376, 382 and 388 arranged in the layout region 360 shown in FIG. 14, the result of layout shown in FIG. 16 is obtained.

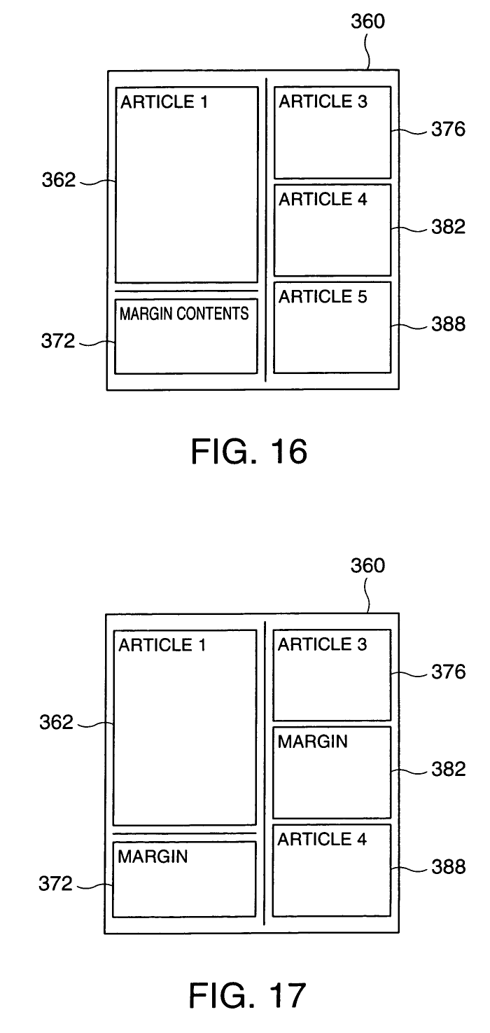

On the contrary, as shown in examples 1 and 2 of the related art, if a similar layout is made only on the basis of identification information or region recognition symbol, the result of layout shown in FIG. 17 is obtained. The difference between the result obtained from the related art and that of the present invention is in that the layout frames 372 and 382 become blank and article 4 is stored in the layout frame 388.

On the other hand, an article storing process is performed on all the pages of the layout definition file read in step S210. As a result, articles are arranged in the layout region 360 of all the pages, thereby resulting in an output layout for digital contents. If an output layout is determined, steps S222 and S224 are undertaken to read a distribution address from the user profile table 300 and to distribute the completed digital contents for provision to the read distribution address.

As described above, in this exemplary embodiment, the content distribution terminal 100 determines whether there are a layout frame and article information having added thereto identical identification information by comparing the identification information added to the article information with that added to the layout frame, to store the article information on the relevant layout frame when it is determined that there are a layout frame and article information having added thereto identical identification information, and to store the article information in the layout frame on the basis of the arrangement control information added to the layout frame and article information when it is determined that there are no layout frame and article information having added thereto identical identification information.

As a result, if there are no layout frame and article information having added thereto identical identification information, the article information is stored in the layout frame on the basis of the arrangement control information, thereby reducing the probability that the layout frame becomes blank in comparison with the related art. Further, if the arrangement control information is added to the article information in accordance with the contents or properties of the article information, the article information is stored in the layout frame on the basis of the arrangement control information added to the article information. Therefore, in comparison with the related art, the present invention makes it possible to make an adjustment for the layout in accordance with the contents or properties of the article information.

Moreover, in this exemplary embodiment, when there is no article information having added thereto identification information identical to that added to the layout frame as a target to be stored, in the content registration DB 42, the content distribution terminal 100 is adapted to select an article information not having added thereto identification information from the content registration DB 42 and to store the selected article information in the layout frame as a target to be stored.

As a result, if there is no layout frame and article information having added thereto identical identification information, article information not having added thereto identification information is selected from the content registration DB 42, thereby reducing the possibility of damaging another combination of the layout frame and article information having added thereto identical identification information. Therefore, it is possible to more properly adjust the layout in accordance with the contents or properties of the article information.

Moreover, in this exemplary embodiment, when there is no article information not having added thereto identification information in the content registration DB 42, the content distribution terminal 100 is adapted to select the article information having arrangement control information set to “may be different” from the content registration DB 42 and to store the selected article information in the layout frame as a target to be stored.

As a result, if there is no article information not having added thereto identification information, article information having arrangement control information set to “may be different” is selected from the content registration DB 42. Therefore, it is possible to further decrease the possibility of damaging other combinations of the layout frame and article information having added thereto identical identification information. Therefore, it is possible to more properly adjust the layout in accordance with the contents or properties of the article information.

Furthermore, in this exemplary embodiment, if there is a layout frame where article information cannot be stored by any other technique in the layout region, the content distribution terminal 100 is adapted to delete the layout frame.

As a result, if there is a layout frame where article information cannot be stored by any other technique in the layout region, the layout frame is deleted. Therefore, it is possible to further reduce the possibility that the layout frame becomes blank.

Moreover, in this exemplary embodiment, if there is a layout frame where article information cannot be stored by any other technique in the layout region, the content distribution terminal 100 is adapted to store margin-filling information.

As a result, if there is a layout frame where article information cannot be stored by any other technique in the layout region, margin-filling information is stored in the layout frame. Therefore, it is possible to further reduce the possibility that the layout frame becomes blank.

Furthermore, in this exemplary embodiment, the content distribution terminal 100 is adapted to take as target identification information having a predetermined level of priority, among the identification information added to the article information and, if there is no article information having added thereto identification information identical to that added to the layout frame as a target to be stored, in the content registration DB 42, to take as target identification information having a priority one level lower than the predetermined level of priority, among the identification information added to the article information and to select article information having added thereto identification information identical to that added to the layout frame as a target to be stored from the content registration DB 42.

As a result, a reference is sequentially made depending on the level of priority of a plurality of pieces of identification information added to the article information, so that it is possible to increase the number of combinations between the layout frame and article information having added thereto identical identification information, and to reduce the possibility of leaving the layout frame blank.

Furthermore, in this exemplary embodiment, the content distribution terminal 100 is adapted to take as target identification information having a predetermined level of priority, among the identification information added to the layout frame and, if there is no layout frame having added thereto identification information identical to that added to the article information as a target to be stored, in the layout region, to take a target identification information having a priority one level lower than the predetermined level of priority, among the identification information added to the layout frame and to select a layout frame having added thereto the identification information identical to that added to the article information as a target to be stored from the layout region.

As a result, a reference is sequentially made depending on the level of priority of a plurality of pieces of identification information added to the layout frames, so that it is possible to increase the number of combinations between layout frame and article information having added thereto the identical identification information and to further reduce the possibility of leaving the layout frame blank.

Moreover, in this exemplary embodiment, the content distribution terminal 100 is adapted to search digital contents from the content registration DB 42 on the basis of the user information of the user information registration DB 40.

As a result, since the unique information of the user as well as the information designated by the user is used for reference regarding the selection of digital contents, it is possible to make up the digital contents to be provided which are relatively suitable for the demands of the user.

Moreover, in this exemplary embodiment, the content distribution terminal 100 is adapted to make up the digital contents to be provided by determining an output layout for the digital contents on the basis of the user information of the user information registration DB 42.

As a result, since the unique information of the user as well as the information designated by the user is used for reference regarding the decision of an output layout, it is possible to make up digital contents to be provided which are relatively suitable for the demands of the user.

In the above first exemplary embodiment, the user information registration DB 40 corresponds to the user information storage device in the nineteenth or twentieth aspects of the invention, while the content registration DB 42 relates to the published information storage device in the second, fourth, sixth, seventh, seventeenth, nineteenth, twenty-sixth or twenty-eighth aspects of the invention. Steps S400 to S424 correspond to the layout device in the first to fourth, sixth, seventh, fourteenth, fifteenth or seventeenth to twenty-fourth aspects of the invention, or the layout step in the twenty-fifth to twenty-eighth aspects of the invention. Further, article information corresponds to the published information in the first to seventh, fourteenth, fifteenth, and seventeenth to twenty-eighth aspects of the invention, while the layout frame corresponds to the information storage region in the first to seventh, fourteenth, fifteenth, seventeenth, eighteenth or twenty-first to twenty-eighth aspects of the invention. “Must be identical” corresponds to state 1 in the fifth aspect of the invention, while “may be different” corresponds to state 2 in fifth-seventh aspects of the invention.

Moreover, in the above first exemplary embodiment, margin contents correspond to margin-filling information.

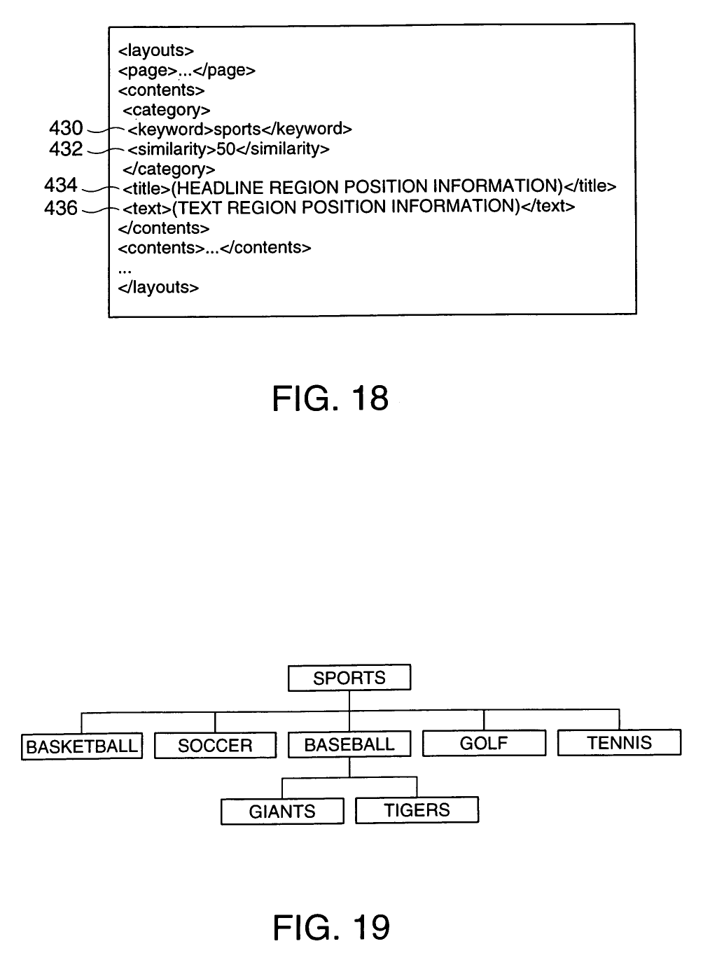

Next, the second exemplary embodiment of the present invention is described with reference to drawings. FIGS. 18 to 20 illustrate the second exemplary embodiment of a layout system, a layout program and a layout method according to the present invention. Further, hereinafter, a description is only provided regarding parts of the second exemplary embodiment different from those of the first exemplary embodiment. The same reference numerals are given to parts of the second exemplary embodiment similar to those of the first exemplary embodiment and the description thereof is omitted.

This exemplary embodiment relates to the application of a layout system, a layout program and a layout method to the case in which the content distribution terminal 100, as shown in FIG. 1 is used to distribute digital contents, such as news, to the user terminal 200. A difference from the first exemplary embodiment is that the similarity of identification information is set as arrangement control information.

First, a data structure in the layout frame is described in detail with reference to FIG. 18. FIG. 18 illustrates the data structure of article information.

The layout frame, as shown in FIG. 18, is adapted to set respective items with a tag set of a starting tag and a finishing tag between a predetermined starting tag (for example, <contents>) and a finishing tag (</contents>).

In the layout frame, a tag set 430 to set identification information to make a correspondence between the layout frame and article information, a tag set 432 to set arrangement control information to control the arrangement thereof in the layout frames, a tag set 434 to set a headline character information storage region, and a tag set 436 to set a text character information storage region are described. In the example of FIG. 18, only one piece of identification information is set. However, a plurality of pieces of identification information can be added to the layout frame along with priority thereof. In the case of enclosure of a plurality of pieces of identification information, the earlier described identification information is set to get the higher level of priority.

The arrangement control information is made to be capable of setting the similarity of identification information. In the example of FIG. 7, “50” is set as arrangement control information. It means that article information having added thereto the identification information having similarity of over 50% to identification information added to the layout frame may be stored in the layout frame if there is no article information having added thereto identification information identical to that added to the layout region.

The similarity between pieces of identification information, as shown in FIG. 19, is set with a value according to the distance between the pieces of identification information in a word system when the meanings of words given as identification information are systemized. In FIG. 19, for example, identification information “giants” and “baseball” are determined to be a distance of 1 in the word system. FIG. 19 illustrates the word system when it is made of the meanings of the words given as identification information.

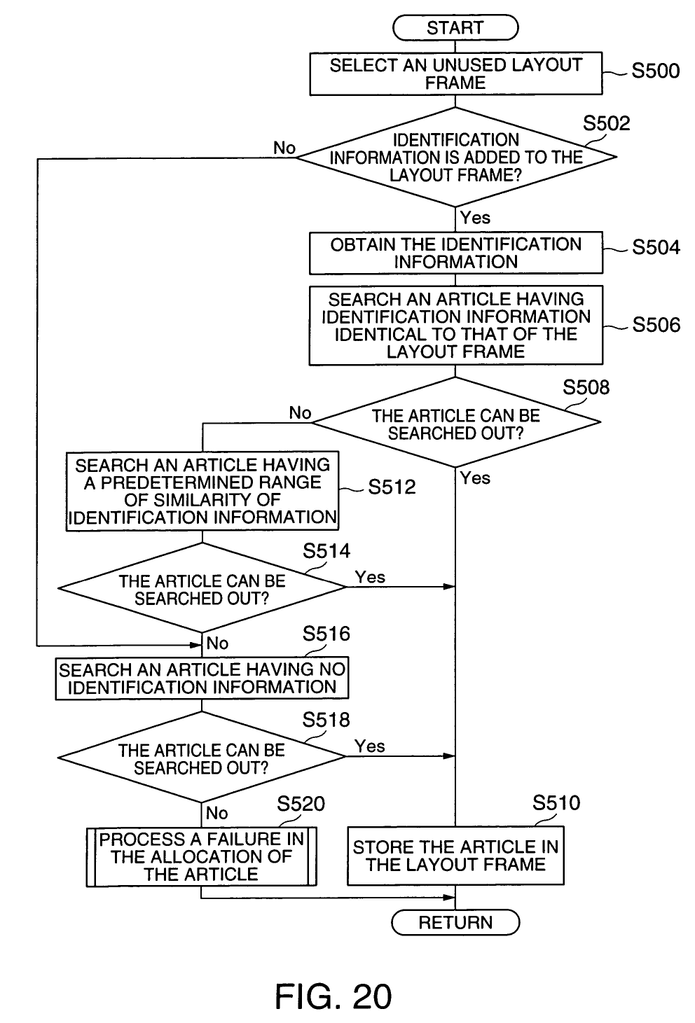

CPU 30 operates a predetermined program stored in a predetermined region of ROM 32, and performs a storage process in a layout frame shown in the flowchart of FIG. 20 according to the program instead of the storage process in the layout frame shown in the flowchart of FIG. 13. FIG. 20 is a flowchart illustrating a storage process in the layout frame of step S312.

The storage process in the layout frame is a process to store article information to a layout frame on the basis of identification information and arrangement control information. After the process is performed in step S316, the flow first proceeds to step S500 as shown in FIG. 20.

In step S500, an unused layout frame storing no article information is selected as a target to be stored from the present layout region 360. Next, the flow proceeds to step S502 where it is determined whether identification information is added to the layout frame as a target to be stored. If it is determined that the identification information is added to the layout frame (Yes), the flow proceeds to step S504.

In step S504, identification information added to the layout frame as a target to be stored is obtained. The flow proceeds to step S506 where an article having added thereto identification information identical to the identification information added to the layout frame as a target to be stored is searched from the digital contents searched out in step S206. The flow proceeds to step S508 where it is determined whether the relevant article can be searched out by a searching operation. If it is determined that the relevant article can be searched out (Yes), the flow proceeds to step S510 where the searched-out article is stored in the layout frame as a target to be stored. A series of steps in the process are finished, and the flow returns to the original processing step.

On the other hand, in step S508, if it is determined that the relevant article cannot be searched out by the searching operation in step S506 (No), the flow proceeds to step S512 where it is determined that an article having added thereto identification information whose similarity to the identification information added to the layout frame as a target to be stored is greater than that of the arrangement control information is searched from the digital contents searched out in step S206. The flow proceeds to step S514 where it is determined whether the relevant article can be searched out by the searching operation. If it is determined that the relevant article can be searched out (Yes), the flow proceeds to step S510.

On the other hand, in step S514, if it is determined that the article cannot be searched out by the searching operation of step S512 (No), the flow proceeds to step S516 where the article not having added thereto identification information is searched from the digital contents searched out in step S206. Next, the flow further proceeds to step S518 where it is determined whether the relevant article can be searched out by the searching operation. If it is determined that the relevant article can be searched out (Yes), the flow proceeds to step S510.

On the other hand, in step S518, if it is determined that the relevant article cannot be searched out by the searching operation of step S516 (No), the flow proceeds to step S520 where a process is performed to cope with the case that there is no suitable article. A series of steps in the process are finished, and the flow returns to the original processing step. Specifically, in step S522, the process is performed to delete the layout frame as a target to be stored or to store the margin contents of image information to show pictures, illustrations or other images, advertisement information, coupon information or the like, in the layout frame as a target to be stored.

On the other hand, in step S502, if it is determined that identification information is not added to the layout frame as a target to be stored (No), the flow proceeds to step S516.

Operations of this exemplary embodiment are described below.

In the course of the layout process, steps S300 to S306 are undertaken to determine the position of a fixed line, the shape and position of fixed character information and the shape and position of fixed image information in sequence. Next, step S312 is repeated to perform an article storing process to store an article in a layout frame for the layout region 360 of respective pages.

In the article storing process, steps S500 and S502 are undertaken to select an unused layout frame as a target to be stored and to determine whether identification information is added to the layout frame as a target to be stored. As a result, if it is determined that the identification information is added to the layout frame, steps S504 and S506 are undertaken to obtain the identification information added to the layout frame as a target to be stored and to search an article having added thereto identification information identical to that added to the layout frame as a target to be stored. As a result, if the relevant article is searched out, step S510 is undertaken to store the searched-out article in the layout frame as a target to be stored.

On the other hand, if an article having added thereto identification information identical to that added to the layout frame as a target to be stored is not searched out, step S512 is undertaken to search an article having added thereto identification information whose similarity to the identification information added to the layout frame as a target to be stored is greater than that of the arrangement control information. As a result, if the relevant article is searched out, the searched-out article is stored in a layout frame as a target to be stored.

On the other hand, if an article having added thereto the identification information whose similarity is greater than that of arrangement control information is not searched out, step S516 is undertaken to search an article not having added thereto identification information. As a result, if the relevant article is searched out, the searched-out article is stored in the layout frame as a target to be stored.

On the other hand, if an article not having added thereto identification information is not searched out, step S520 is undertaken to perform a process to cope with the case that there is no suitable article, for example, an operation of storing margin contents in the layout frame as a target to be stored.

Moreover, if there is no identification information in the layout frame as a target to be stored, step S516 is undertaken to search an article not having added thereto identification information. As a result, if the relevant article is searched out, the searched-out article is stored in the layout frame as a target to be stored. On the other hand, if an article is not searched out, a process is performed to cope with the case that there is no suitable article.

As described above, in this exemplary embodiment, arrangement control information can set the similarity of identification information that is allowable when article information is stored in a layout frame having added thereto identical identification information.

When the similarity of arrangement control information is set higher, the possibility of storing the article information in the layout frame having added thereto identical identification information is higher. However, if the similarity of arrangement control information is set lower, there is a possibility that the article information can be stored in a layout frame other than the one having identical identification information. Therefore, if the similarity of the arrangement control information is set in accordance with the contents or properties of article information, a better adjustment can be made to the layout.

Moreover, in this exemplary embodiment, if there is no article information having added thereto identification information identical to that added to the layout frame as a target to be stored, in the content registration DB 42, the content distribution terminal 100 is adapted to select article information having added thereto identification information whose similarity to the identification information added to the layout frame as a target to be stored is greater than that of arrangement control information, from the content registration DB 42, and to store the selected article information in the layout frame as a target to be stored.

As a result, if there is no layout frame and article information having added thereto the identical identification information, article information having added thereto identification information whose similarity to the identification information added to the layout frame as a target to be stored is greater than that of arrangement control information, is selected from the content registration DB 42. Therefore, it is possible to reduce the possibility of damaging the contents to be stored in the layout frame. Therefore, it is possible to more properly adjust the layout in accordance with the contents or properties of the article information.

Moreover, in this exemplary embodiment, the similarity is set with a value according to the distance between the pieces of identification information in a word system when the meanings of words given as identification information are systemized.

As a result, since the similarity is set by using a distance between two pieces of identification information in the word system when the meanings of words given as identification information are systemized, it is possible to regulate the similarity relationship, which is relatively suitable for actual conditions.

In the above second exemplary embodiment, the user information registration DB 40 corresponds to the user information storage device in the nineteenth or twentieth aspects of the invention, while the content registration DB 42 corresponds to the published information storage device in the second, fourth, eleventh, seventeenth, nineteenth, twenty-sixth or twenty-eighth aspects of the invention. Steps S500 to S520 correspond to the layout device in the first to fourth, eleventh, fourteenth, fifteenth or seventeenth to twenty-fourth aspects of the invention, or the layout step in the twenty-fifth to twenty-eighth aspects of the invention.

Further, article information corresponds to the published information in the first to fourth, tenth, eleventh, fourteenth, fifteenth or seventeenth to twenty-eighth aspects of the invention, while the layout frame corresponds to the information storage region in the first to fourth, tenth, eleventh, fourteenth, fifteenth, seventeenth, eighteenth, or twenty-first to twenty-eighth aspects of the invention. Margin contents correspond to the margin-filling information in the fifteenth aspect of the invention.

Moreover, in the above first exemplary embodiment, when there is no article information having added thereto identification information identical to that added to the layout frame as a target to be stored, in the content registration DB 42, the content distribution terminal 100 is constructed to select article information not having added thereto identification information from the content registration DB 42 and to store the selected article information in the layout frame as a target to be stored. However, it is not limited thereto, but it is possible to select a layout frame suitable for an article from the layout region 360. At this time, the following construction can be adopted as a corresponding construction. In other words, if the layout region 360 includes no layout frame having added thereto identification information identical to the identification information added to article information as a target to be stored, the layout frame not having added thereto identification information is selected from the layout region 360 and the article information as a target to be stored, is stored in the selected layout frame.

If there is no layout frame and article information having added thereto identical identification information, the layout frame not having added thereto identification information is selected from the layout region 360. Therefore, it is possible to reduce the possibility of damaging other combinations between the layout frame and article information having added thereto identical identification information. Thus, it is possible to more properly adjust the layout in accordance with the contents or properties of the article information.

At this time, steps S400 to S424 correspond to the layout device in the eighth aspect of the invention. Article information corresponds to the published information in the eighth aspect of the invention, while the layout frame corresponds to information storage region in the eighth aspect of the invention.

Moreover, in the above first exemplary embodiment, when there is no article information not having added thereto identification information in the content registration DB 42, the content distribution terminal 100 is constructed to select article information having arrangement control information set to “may be different” from the content registration DB 42 and to store the selected article information in the layout frame as a target to be stored. However, it is not limited thereto, but it is possible to select a layout frame suitable for an article from the layout region 360. At this time, the following construction can be adopted as a corresponding construction. In other words, if the layout region 360 includes no layout frame not having added thereto identification information in the layout region 360, the layout frame having arrangement control information set to “may be different” is selected from the layout region 360 and the article information as a target to be stored, is stored in the selected layout frame.

As a result, if there is no layout frame not having added thereto identical information, the layout frame having arrangement control information set to “may be different” is selected from the layout region 360. Therefore, it is possible to further reduce the possibility of damaging other combinations between the layout frame and article information having added thereto identical identification information. Thus, it is possible to more properly adjust the layout in accordance with the contents or properties of the article information.

At this time, steps S400 to S424 correspond to the layout device in the ninth aspect of the invention. Article information corresponds to the published information in the ninth aspect of the invention, while the layout frame corresponds to information storage region in the ninth aspect of the invention. “May be different” corresponds to state 2 in the ninth aspect of the invention.

Moreover, in the above second exemplary embodiment, when there is no article information having added thereto identification information identical to that added to the layout frame as a target to be stored, in the content registration DB 42, the content distribution terminal 100 is constructed to select article information having added thereto the identification information whose similarity to the identification information added to the layout frame as a target to be stored is greater than the similarity of the arrangement control information, from the content registration DB 42 and to store the selected article information in the layout frame as a target to be stored. However, it is not limited thereto, but it is possible to select a layout frame suitable for an article from the layout region 360. At this time, the following construction can be adopted as a corresponding construction. In other words, if there is no layout frame having added thereto identification information identical to that added to the article information as a target to be stored, in the layout region 360, the layout frame having added thereto the identification information whose similarity to the identification information added to the layout frame as a target to be stored is greater than that of arrangement control information is selected, from the layout region 360 and the selected layout frame stores the article information as a target to be stored.

As a result, if there is no layout frame and article information having added thereto identical identification information, the layout frame having added thereto the identification information, whose similarity to the identification information added to the article information as a target to be stored is greater than that of arrangement control information, is selected from the layout region 360. Therefore, it is possible to further reduce the possibility of damaging the contents to be stored in the layout frame. As a result, it is possible to more properly adjust the layout in accordance with the contents or properties of the article information.

At this time, steps S500 to S520 correspond to the layout means in invention 12. Article information corresponds to the published information in invention 12, while the layout frame corresponds to the information storage region in invention 12.

Moreover, in the above first and second exemplary embodiments, it has been described that article information has previously added thereto identification information, but it is not limited thereto. However, the data structure may be constructed in a way that the contents of article information are analyzed and identification information can be added to the article information on the basis of the result of analysis.

As a result, since the identification information is added to article information according to the contents thereof, it is possible to add relatively suitable identification information to the article information and to reduce the trouble of uniformly adding identification information to the article information.

In addition, in the above first and second exemplary embodiments, character information and image information are used as article information. However, it is not limited to the character and image information, but mobile image information, voice information or other multimedia data may be used as article information.

Further, in the above first and second exemplary embodiments, it is constructed to determine whether there is article information having added thereto identification information identical to that added to the layout frame as a target to be stored, in the content registration DB 42. However, the data structure is not limited thereto, and it can be constructed to determine whether there is article information having added thereto identification information related to the identification information added to the layout frame as a target to be stored, in the content registration DB 42.

Additionally, the above first and second exemplary embodiments are constructed to make a layout while the shape and position of the layout frames are dynamically determined. However, it is not limited thereto, and it can also be constructed to make a layout by determining the shape and position of each layout frame after information is stored in all the layout frames of the layout region 360.

Further, in the above first and second exemplary embodiments, it is constructed to determine an output layout for digital contents on the basis of user information. However, it is not limited thereto, and it can also be constructed to determine an output layout for digital contents on the basis of the number of images or the amount of character information included in the digital contents.

As a result, even if the number of images or the amount of character information included in the digital contents gets greater or smaller, it is possible to make an output layout to be read with ease.

Moreover, in the above first and second exemplary embodiments, it is constructed to perform the process of making a layout in step S212 in the content distribution terminal 100. However, it is not limited thereto, but it can be constructed to perform the layout process in the user terminal 200. As a result, it is possible to reduce the concentration of the processing load on the content distribution terminal 100.

Furthermore, in the above first and second exemplary embodiments, a description has been provided regarding a case that a control program previously stored in ROM 32 is carried out for all the processes shown in the flowcharts of FIGS. 10 to 13 and FIG. 20. However, it is not limited thereto, but the processes can be carried out by reading the program at RAM 34 from the storage medium having a memory of the program showing the sequence of processes.

At this time, the storage medium includes semiconductor storage medium, such as RAM or ROM, magnetic storage type storage medium such as FD or HD, optical reading type storage medium, such as CD, CDV, LD or DVD, and magnetic storage/optical reading type storage medium. Regardless of the electronic, magnetic or optical reading method, it is possible to include any storage medium capable of reading information on the computer.

Additionally, in the above exemplary embodiments, a description has been provided regarding a case that the layout system, layout program and layout method of the present invention are applied to a network system constructed by the internet 199. However, it is not limited thereto, but it may be applied to a case that a communication is made by the method identical to the internet 199, so called, the intranet. The invention is not limited to the network in which the communication is made by the method identical to the internet 199, but it may be applied to a general network.

Moreover, in the above exemplary embodiments, the layout system, layout program and layout method of the invention are applied to a case that digital contents, such as news, are distributed from the content distribution terminal 100 to the user terminal 200 as shown in FIG. 1. However, it is not limited thereto, but it can be applied to other cases without departing from the scope of the invention.

As described above, according to the layout system of the first to third aspects of the present invention, if information storage regions and published information cannot be made to correspond on the basis of identification information, they can be made to correspond on the basis of arrangement control information. In comparison with the related art, the present invention can reduce the possibility of leaving the information storage region blank. Moreover, since arrangement control information is added to the published information in accordance with the contents or properties thereof, an adjustment can be made to the layout in accordance with the contents or properties of the published information.

Furthermore, according to the layout system of the second and fourth to twentieth aspects of the present invention, if there is no information storage region and published information having added thereto identical or related identification information, published information is stored on the basis of arrangement control information. In comparison with the prior art, the present invention can reduce the possibility of leaving the information storage region blank. Further, if the arrangement control information is added to the published information in accordance with the contents or properties thereof, the published information is stored in the information storage region on the basis of arrangement control information added to the relevant published information. In comparison with the prior art, the present invention can adjust the layout in accordance with the contents or properties of the published information.

Furthermore, according to the layout system of the fifth to ninth aspects of the present invention, if the arrangement control information is set to state 1, the published information has a greater possibility of being stored in the information storage region having added thereto identical or related identification information. If the arrangement control information is set to state 2, the published information has a possibility of being stored in an information storage region other than the one having added thereto identical or related identification information. Therefore, if the arrangement control information is set to either state 1 or state 2 in accordance with the contents or properties of the published information, the present invention results in a better adjustment to the layout in accordance with the contents or properties of the published information.

Furthermore, according to the layout system of the sixth or seventh aspects of the present invention, if there is no information storage regions and published information having added thereto identical or related identification information, the published information not having added thereto identification information is selected from the published information storage means. Therefore, it is possible to reduce the possibility of damaging other combinations between the information storage regions and the published information having added thereto the identical or related identification information. Thus, the present invention results in a better adjustment to the layout in accordance with the contents or properties of the published information.

According to the layout system of the seventh aspect of the present invention, if there is no published information not having added thereto identification information, published information having arrangement control information set to state 2 is selected from the published information storage means. Therefore, it is possible to further reduce the possibility of damaging other combinations between the information storage regions and the published information having added thereto the identical or related identification information. Thus, the present invention results in a better adjustment to the layout in accordance with the contents or properties of the published information.

Moreover, according to the layout system of the eighth or ninth aspects of the present invention, if there are no information storage regions and published information not having added thereto identical or related identification information, information storage region not having added thereto identification information is selected from the layout region. Therefore, it is possible to further reduce the possibility of damaging other combinations between information storage regions and published information having added thereto identical or related identification information. As a result, the present invention results in a better adjustment to the layout in accordance with the contents or properties of the published information.

Furthermore, according to the layout system of the ninth aspect of the present invention, if there are no information storage regions not having added thereto identification information, the information storage region having arrangement control information set to state 2 is selected from the layout region. Therefore, it is possible to further reduce the possibility of damaging other combinations between the information storage regions and the published information having added thereto the identical or related identification information. Thus, the present invention results in a better adjustment to the layout in accordance with the contents or properties of the published information.

Moreover, according to the layout system of the tenth to thirteenth aspects of the present invention, if the similarity of the arrangement control information is set higher, the published information has a greater possibility of being stored in the information storage region having added thereto identical or related identification information. On the contrary, if the similarity of the arrangement control information is set lower, published information has a possibility of being stored in the information storage region other than the one having added thereto the identical or related identification information. Therefore, if the similarity of the arrangement control information is set in accordance with the contents or properties of the published information, the present invention results in a better adjustment to the layout in accordance with the contents or properties of the published information.

Furthermore, according to the layout system of the eleventh aspect of the present invention, if there are no information storage regions and published information having added thereto identical or related identification information, the published information having added thereto the identification information whose similarity to the identification information having added thereto the information storage region as a target to be stored is greater than the similarity of the arrangement control information is selected from the published information storage means. Therefore, it is possible to further reduce the possibility of damaging the contents to be stored in the information storage region. As a result, a better adjustment can be made to the layout in accordance with the contents or properties of the published information.

In addition, according to the layout system of the twelfth aspect of the present invention, if there are no information storage regions and published information having added thereto identical or related identification information, the information storage region having added thereto the identification information whose similarity to the identification information having added thereto the published information as a target to be stored is greater than the similarity of the arrangement control information is selected from the layout region. Therefore, it is possible to further reduce the possibility of damaging the contents to be stored in the information storage region. As a result, a better adjustment can be made to the layout in accordance with the contents or properties of the published information.

In addition, according to the layout system of the thirteenth aspect of the present invention, since the similarity is set as the value according to the distance between the pieces of identification information in a word system when the meanings of words given as identification information are systemized, it can regulate the similarity relationship which is relatively suitable for actual conditions.

Furthermore, according to the layout system of the fourteenth aspect of the present invention, if there is an information storage region where the published information cannot be stored by any technique in the layout region, the information storage region is deleted. Therefore, it can further reduce the possibility of leaving the information storage region blank.

Moreover, according to the layout system of the fifteenth aspect of the present invention, if there is an information storage region where the published information cannot be stored by any technique in the layout region, margin-filling information is stored in the information storage region. Therefore, it can further reduce the possibility of leaving the information storage region blank.

Furthermore, according to the layout system of the sixteenth aspect of the present invention, since the published information has added thereto identification information in accordance with the contents of the published information, it is possible to add relatively suitable identification information to the published information and to effectively reduce the trouble of adding the identification information to the published information.

Moreover, according to the layout system of the seventeenth aspect of to the present invention, since a plurality of the pieces of identification information added to the published information are referred in the sequence of priority added thereto, it is possible to increase the number of combinations between the information storage regions and the published information having added thereto identical or related identification information and to further reduce the possibility of leaving information storage region blank.

Furthermore, according to the layout system of the eighteenth aspect of the present invention, since a plurality of the pieces of identification information added to the information storage region are referred in the sequence of priority, it is possible to increase the number of combinations between the information storage regions and the published information having added thereto identical or related identification information and to further reduce the possibility of leaving information storage region blank.

Further, according to the layout system of the nineteenth aspect of the present invention, since unique information of a user or the information designated by the user is referred in relation with the selection of the published information, it can make up the contents of the published information which is relatively suitable for the user's demands.

Furthermore, according to the layout system of the twentieth aspect of the present invention, since unique information of a user or the information designated by the user is referred in relation to the layout, it can make up the contents of published information which is relatively suitable for the user's desire.

On the other hand, according to the layout program of the twenty-first aspect of the present invention, it is possible to achieve the same effect as the layout system of the first aspect.

Moreover, according to the layout program of the twenty-second aspect of the present invention, it is possible to achieve the same effect as the layout system of the second aspect of the present invention.

Moreover, according to the layout program of the twenty-third aspect of the present invention, it is possible to achieve the same effect as the layout system of the third aspect of the present invention.

Furthermore, according to the layout program of the twenty-fourth aspect of the present invention, it is possible to achieve the same effect as the layout system of the fourth aspect of the present invention.

On the other hand, according to the layout method of the twenty-fifth aspect of the present invention, it is possible to achieve the same effect as the layout system of the first aspect of the present invention.

Moreover, according to the layout method of the twenty-sixth aspect of the present invention, it is possible to achieve the same effect as the layout system of the second aspect of the present invention.

In addition, according to the layout method of the twenty-seventh aspect of the present invention, it is possible to achieve the same effect as the layout system of the third aspect of the present invention.

Moreover, according to the layout method of the twenty-eighth aspect of the present invention, it is possible to achieve the same effect as the layout system of the fourth aspect of the present invention.

What is claimed is:

1. A layout system, comprising:
a layout device to select published information from a plurality of pieces of published information and to make a layout for the selected published information, the layout device performing a layout process by storing the selected published information in information storage regions arranged in a layout region;
the information storage regions and the published information having respectively added thereto identification information to make the information storage regions and the published information correspond to each other, and the published information having added thereto arrangement control information to control the arrangement in the information storage regions; and
the layout device being adapted to store the published information in the information storage regions on the basis of the arrangement control information when there are no information storage regions or published information suitable to store the published information in the information storage regions on the basis of the identification information.

2. A layout system, comprising:
a published information storage device to store a plurality of pieces of published information; and
a layout device to select the published information from the published information storage device and to make a layout for the selected published information, the layout device performing a layout process by storing the selected published information in information storage regions arranged in a layout region;
the information storage regions and the published information having respectively added thereto identification information to make the information storage regions and the published information correspond to each other, and the published information having added thereto arrangement control information to control the arrangement in the information storage regions; and
the layout device being adapted to determine whether there are an information storage region and published information having added thereto identical or related identification information by comparing the identification information added to the published information with that added to the information storage regions, and then, when it is determined that there are an information storage region and published information having added thereto identical or related identification information, the layout device being adapted to store relevant published information in the relevant information storage region, and when it is determined that there are no information storage regions and published information having added thereto identical or related identification information, the layout device being adapted to store the published information in the information storage regions on the basis of arrangement control information added to the relevant published information.

3. A layout system, comprising:
a layout device to select published information from a plurality of pieces of published information and to make a layout for the selected published information, the layout device performing a layout process by storing the selected published information in information storage regions arranged in a layout region;
the information storage regions and the published information having respectively added thereto identification information to make the information storage regions and the published information correspond to each other, and arrangement control information to control the arrangement in the information storage regions; and
the layout device being adapted to store the published information in the information storage regions on the basis of the arrangement control information when there are no information storage regions or published information suitable to store the published information in the information storage regions on the basis of the identification information.

4. A layout system, comprising:
a published information storage device to store a plurality of pieces of published information; and
a layout device to select the published information from the published information storage device and to make a layout for the selected published information, the layout device performing a layout process by storing the selected published information in information storage regions arranged in a layout region;
the information storage regions and the published information having respectively added thereto identification information to make the information storage regions and the published information correspond to each other, and arrangement control information to control the arrangement in the information storage regions; and
the layout device being adapted to determine whether there are an information storage region and published information having added thereto identical or related identification information by comparing the identification information added to the published information with that added to the information storage regions, and then, when it is determined that there are an information storage region and published information having added thereto identical or identification information, the layout device being adapted to store relevant published information in the relevant information storage region, and when it is determined that there are no information storage regions and published information having added thereto identical or related identification information, the layout device being adapted to store the published information in the information storage region on the basis of the arrangement control information added to the information storage region and the published information.

5. The layout system according to claim 4, the arrangement control information being settable to either state 1 where the published information should be stored in an information storage region having added thereto identification information identical or related thereto, or state 2 where the published information may be stored in an information storage region other than the one having added thereto identification information identical or related thereto.

6. The layout system according to claim 5, when there is no published information having added thereto identification information identical or related to that added to an information storage region as a target to be stored, in the published information storage device, and when arrangement control information added to the information storage region is set to state 2, the layout device being adapted to select published information not having added thereto the identification information from the published information storage device, and to store the selected published information in the information storage region as a target to be stored.

7. The layout system according to claim 6, when there is no published information not having added thereto identification information, in the published information storage device, the layout device being adapted to select published information having the arrangement control information set to the state 2 from the published information storage device and to store in the information storage region as a target to be stored the selected published information.

8. The layout system according to claim 5, when there is no information storage region having added thereto identification information identical or related to that added to the published information as a target to be stored, in the layout region, and when the arrangement control information added to the published information is set to the state 2, the layout device being adapted to select an information storage region not having added thereto the identification information from the layout region and to store in the selected information storage region the published information as a target to be stored.

9. The layout system according to claim 8, when there are no information storage regions not having added thereto the identification information, in the layout region, the layout device being adapted to select an information storage region having the arrangement control information set to the state 2 from the layout region, and to store in the selected information storage region the published information as a target to be stored.

10. The layout system according to claim 4, the arrangement control information being able to set the similarity of identification information which is allowable when the published information is stored in an information storage region having added thereto identification information identical or related to the published information.

11. The layout system according to claim 10, when there is no published information having added thereto identification information identical or related to that added to an information storage region as a target to be stored, in the published information storage device, the layout device being adapted to select from the published information storage device published information having added thereto the identification information whose similarity to the identification information added to the information storage region as a target to be stored is greater than that of the arrangement control information added to the information storage region as a target to be stored, and to store the selected published information in the information storage region as a target to be stored.

12. The layout system according to claim 10, when there are no information storage regions having added thereto identification information identical or related to that added to the published information as a target to be stored, in the layout region, the layout device being adapted to select from the layout region the information storage region having added thereto the identification information whose similarity to the identification information added to the published information as a target to be stored is greater than that of the arrangement control information added to the published information as a target to be stored, and to store in the selected information storage region the published information as a target to be stored.

13. The layout system according to claim 10, the similarity being a value according to the distance between the pieces of identification information in a word system when the meanings of words given as the identification information are systemized.

14. The layout system according to claim 4, when there is, in the layout region, an information storage region where the published information cannot be otherwise stored, the layout device being adapted to delete the relevant information storage region.

15. The layout system according to claim 4, when there is, in the layout region, an information storage region where the published information cannot be otherwise stored, the layout device being adapted to store margin-filling information in the relevant information storage region.

16. The layout system according to claim 4, further comprising an identification-information adding device to add the identification information to the published information,
the identification-information adding device being adapted to analyze the contents of the published information and to add the identification information to the published information on the basis of the analysis results.

17. The layout system according to claim 4, the published information having added thereto a plurality of pieces of the identification information having priority, and
when identification information having a predetermined level of priority, among the identification information added to the published information is taken as a target and it is determined that there is no published information having added thereto identification information identical or related to that added to an information storage region as a target to be stored, in the published information storage device, the layout device being adapted to take as target identification information having a priority one level lower than the predetermined level of priority, among the identification information added to the published information, and to select from the published information storage device the published information having added thereto identification information identical or related to that added to the information storage region as a target to be stored.

18. The layout system according to claim 4, the information storage region having added thereto a plurality of pieces of the identification information having priority, and
when identification information having a predetermined level of priority, among the identification information added to the information storage regions is taken as a target and it is determined that there are no information storage regions having added thereto identification information identical or related to that added to published information as a target to be stored, in the layout region, the layout device being adapted to take as target identification information having a priority one level lower than the predetermined level of priority, among the identification information added to the information storage regions, and to select from the layout region an information storage region having added thereto identification information identical or related to that added to the published information as a target to be stored.

19. The layout system according to claim 4, further comprising a user information storage device to store user information regarding a user, the layout device being adapted to select published information from the published information storage device on the basis of the user information in the user information storage device.

20. The layout system according to claim 4, further comprising a user information storage device to store user information regarding a user, the layout device being adapted to make a layout for the published information on the basis of the user information in the user information storage device.

21. A layout program, comprising:
a layout program for selecting published information from a plurality of pieces of published information and for making a layout for the selected published information, the layout program performing a layout process by storing the selected published information in information storage regions arranged in a layout region;
the information storage regions and published information having respectively added thereto identification information to make the information storage regions and the published information correspond to each other, and the published information having added thereto arrangement control information to control the arrangement in the information storage regions; and
when there is no information storage region or published information suitable to store the published information in the information storage regions on the basis of the identification information, the layout program being adapted to store the published information in the information storage regions on the basis of the arrangement control information.

22. A layout program, comprising:
a published information storage program for storing a plurality of pieces of published information; and
a layout program for selecting the published information from the published information storage program and for making a layout for the selected published information, the layout program performing a layout process by storing the selected published information in information storage regions arranged in a layout region;
the information storage regions and the published information having respectively added thereto identification information to make the information storage regions and the published information correspond to each other, and the published information having added thereto arrangement control information to control the arrangement in the information storage regions; and
the layout program being adapted to determine whether there are an information storage region and published information having added thereto identical or related identification information by comparing the identification information added to the published information with that added to the information storage regions, and then, when there are an information storage region and published information having added thereto identical or related identification information, the layout program being adapted to store relevant published information in the relevant information storage region, and when there is no information storage region and published information having added thereto identical or related identification information, the layout program being adapted to store the published information in the information storage regions on the basis of arrangement control information added to the relevant published information.

23. A layout program, comprising:
a layout program for selecting published information from a plurality of pieces of published information and for making a layout for the selected published information, the layout program performing a layout process by storing the selected published information in information storage regions arranged in a layout region;
the information storage regions and the published information having respectively added thereto identification information to make the information storage regions and the published information correspond to each other, and arrangement control information to control the arrangement in the information storage regions; and
when there is no information storage region or published information suitable to store the published information in the information storage regions on the basis of the identification information, the layout program being adapted to store the published information in the information storage regions on the basis of the arrangement control information.

24. A layout program, comprising:
a published information storage program for storing a plurality of pieces of published information; and
a layout program for selecting the published information from the published information storage program and for making a layout for the selected published information, the layout program performing a layout process by storing the selected published information in information storage regions arranged in a layout region;
the information storage regions and the published information having respectively added thereto identification information to make the information storage regions and the published information correspond to each other, and arrangement control information to control the arrangement in the information storage regions; and
the layout program being adapted to determine whether there are an information storage region and published information having added thereto identical or related identification information by comparing the identification information added to the published information with that added to the information storage regions, and then, when there are an information storage region and published information having added thereto identical or related identification information, the layout program being adapted to store relevant published information in the relevant information storage region, and when there is no information storage region and published information having added thereto identical or related identification information, the layout program being adapted to store the published information in the information storage regions on the basis of arrangement control information added to the relevant information storage regions and published information.

25. A layout method, comprising:
selecting published information from a plurality of pieces of published information; and
making a layout for the selected published information, the layout being performed by storing the selected published information in information storage regions arranged in a layout region;
the information storage regions and the published information having respectively added thereto identification information to make the information storage regions and the published information correspond to each other, and the published information having added thereto arrangement control information to control the arrangement in the information storage regions; and
when there is no information storage region or published information suitable to store the published information in the information storage regions on the basis of the identification information, the layout being adapted to store the published information in the information storage region on the basis of the arrangement control information.

26. A layout method, comprising:
selecting published information from a published information storage device to store a plurality of pieces of published information; and
making a layout for the selected published information, the layout being performed by storing the selected published information in the information storage regions arranged in a layout region;
the information storage regions and the published information having respectively added thereto identification information to make the information storage regions and the published information correspond to each other, and the published information having added thereto arrangement control information to control the arrangement in the information storage regions; and
the layout determining whether there are an information storage region and published information having added thereto identical or related identification information by comparing the identification information added to the published information with that added to the information storage regions, and then, when there are an information storage region and published information having added thereto identical or related identification information, the layout being adapted to store the published information in the information storage regions, and when there is no information storage region and published information having added thereto identical or related identification information, the layout being adapted to store the published information in the information storage regions on the basis of arrangement control information added to the relevant published information.

27. A layout method, comprising:
selecting published information from a plurality of pieces of published information; and
making a layout for the selected published information, the layout being performed by storing the selected published information in the information storage regions arranged in a layout region;
the information storage regions and the published information having respectively added thereto identification information to make the information storage regions and the published information correspond to each other, and arrangement control information to control the arrangement in the information storage regions; and
when there is no information storage region and published information suitable to store the published information in the information storage regions on the basis the identification information, the layout being adapted to store the published information in the information storage region on the basis of the arrangement control information.

28. A layout method, comprising:
selecting published information from a published information storage device to store a plurality of pieces of published information; and
making a layout for the selected published information, the layout being performed by storing the selected published information in the information storage regions arranged in a layout region;
the information storage regions and the published information having respectively added thereto identification information to make the information storage regions and the published information correspond to each other, and arrangement control information to control the arrangement in the information storage regions; and
the layout determining whether there are an information storage region and published information having added thereto identical or related identification information by comparing the identification information added to the published information with that added to the information storage regions, and then, when there are an information storage region and published information having added thereto identical or related identification information, the layout being adapted to store the published information in the information storage regions, and when there is no information storage region and published information having added thereto identical or related identification information, the layout being adapted to store the published information in the information storage regions on the basis of the arrangement control information added to the information storage region and the published information.
